(19) United States
(12) Patent Application Publication
(10) Pub. No.: US 2006/0175465 A1
(43) Pub. Date: Aug. 10, 2006

(54) Method and a device for lifting and/or lowering of objects at a wind turbine or the like and uses hereof

(76) Inventor: Paul Teichert, Norlundvej 16 (DK)

Correspondence Address: CANTOR COLBURN, LLP, 55 GRIFFIN ROAD SOUTH, BLOOMFIELD, CT, 06002, US

(21) Appl. No.: 10/526,684

(22) PCT Filed: Sep. 4, 2003
(86) PCT No.: PCT/DK03/00577

§ 371 Date: Sep. 21, 2005

(30) Foreign Application Priority Data
Sep. 4, 2002 (DK) PA 2002 01299

(51) Int. Cl. B64B 1/50

(52) U.S. Cl. 244/33

(57) ABSTRACT

Method and device for lifting and/or lowering of objects in connection with a wind turbine or similar construction, where an uplift device is made to lift and/or lower itself in the proximity of the wind turbine or the similar construction, in as much as uplift device is possibly controlled in relation to the wind turbine or the similar construction and where at least one object is supported by said uplift device. The invention further relates to use hereof for lifting and/or lowering of various parts in connection with a wind turbine.

### FIELD OF THE INVENTION

The invention relates to a method for lifting and/or lowering of objects in connection with a wind turbine or a similar construction. The invention also relates to a device for lifting and/or lowering of objects in connection with a wind turbine or a similar construction. Finally, the invention relates to uses of such a method and/or such a device.

### BACKGROUND OF THE INVENTION

In connection with wind turbines, from time to time it will be necessary to undertake actions where it is desirable to be able to effect lifting and/or lowering of certain parts, elements, work equipment etc. For example, this can be the case with the inspection of wind turbine blades, with the cleaning of these, with various forms of treatment of, for example, wind turbine blades, in the replacement of parts such as, for example, a wind turbine blade etc.

With regard to the cleaning of wind turbine blades, is shall thus be mentioned that it is generally recognized within the wind turbine branch that in order to obtain an * optimum output of a wind turbine, the aerodynamic conditions for the wind turbine, including especially the aerodynamic conditions for the rotor blades must be in order. Great efforts are thus made on the part of the manufacturers of the wind turbines to make the rotor blades as effective as possible with the object of achieving a good efficiency. This not only includes the shape of the rotor blades, but also the surface character of the rotor blades, where efforts are made to provide a surface which is as smooth as possible.

But it is thus also acknowledged that already after relatively short-time operation, for example half a year, the rotor blades of a wind turbine can be so defiled by dust, coatings of salt, dead insects, bird excrements and other surface deposits, that the efficiency of a given wind turbine can be reduced by up to 10-15% or even more, depending on the current wind strength.

It has thus also been recognised that it is desirable to carry out a cleaning-off and subsequent sealing of the wind turbine blades at regular intervals, depending on the given location of the wind turbine.

Such cleaning has hitherto been carried out manually, where the wind turbine has been brought to a halt and the turbine has been stopped in positions where the rotor blades have pointed down towards the ground. Hereafter, the individual rotor blades have been washed manually one by one, with use being made of various arrangements for bringing the work crew into the necessary working position and working height.

A lifting arrangement is thus known from German utility model document DE 296 03 278 U where, when the turbine has been brought to a halt with one rotor blade pointing vertically downwards, suspension elements have been secured on each of the two remaining rotor blades near the hub of the rotor. A special work platform with a through-going slot in the bottom has been secured to these suspension arrangements, so that the downwards-pointing rotor blade has been able to be introduced into this slot. Hereafter, the work platform has been able to be hoisted upwards stepwise, while the crew has manually cleaned the surface of the rotor blade, for example with one person placed on each side of the rotor blade.

With such an arrangement, it is a time-consuming and relatively costly and troublesome process to have to undertake a cleaning of the rotor blades of a wind turbine. Moreover, it is a cost-increasing and complicating factor that with such a known arrangement use must be made of mechanical equipment, for example a crane, with which to secure the suspension devices, in that these must be raised to a considerable height.

Moreover, it is known to undertake various inspections in connection with a wind turbine, for example inspections of surfaces of the wind turbine blades as it is also known to carry out various other work operations in connection with wind turbines, said work operations being carried out, for example, with the help of lifting arrangements such as cranes, for example mobile cranes, work-crew baskets etc.

Devices of corresponding kind are known from DE 199 09 698 A1 and DE 43 39 638 A1, which are encumbered with the same disadvantages as those mentioned above, including that use must be made of special material such as cranes, for example mobile cranes, work-crew baskets etc., or relatively comprehensive materials which, for example, are mounted on the turbine tower beforehand.

In connection herewith there will be a number of disadvantages, partly in that it will be a relatively large expense to be able to procure the necessary lifting equipment for these operations, and in that in many situations it can be troublesome not to say impossible to get the necessary lifting equipment to the site for the wind turbines. Out of regard for an optimum energy output, local considerations etc. the wind turbines will namely in many cases be located in places to which the transport possibilities, such as the existence of roads, are not favourable. Thus, it can be impossible or difficult to have to bring a crane to a wind turbine in the winter, in the spring and in the autumn, and on the whole under wet weather conditions. Especially, it can be mentioned that it can be particularly problematic to have to undertake such actions at wind turbines, which are sea-based, in as much as here it must also be taken into consideration that it can be more difficult to operate at sea, and that it can be costly to have to undertake crane manoeuvres at sea.

### THE INVENTION

It is thus an object of the invention to provide a method and a device with which access to wind turbines on the whole or parts thereof, including especially wind turbine rotor blades, can be achieved with equipment which is relatively easy to transport.

It is also an object to provide such a method and such a device with which there can be achieved a considerable rationalisation and reduction in the costs of said working operations.

Further, it is an object to provide a method and a device with which a securing of a locking device can be established on or at a wind turbine, so that by means of such a locking device it will be possible to lift, raise, lower etc various elements and various equipment in connection with a wind turbine.

Moreover, it is a particular object of the invention to achieve a method and a device with which, in a relatively simple manner, the possibility can be established for being able to use a work platform, a cleaning arrangement or the like in connection with wind turbine blades, without the necessity of having to use relatively large and/or complicated lifting arrangements, cranes etc.

It is also an object to provide a method and a device with which, in a relatively simple manner, the possibility is achieved of being able to carry out additional working operations at the same time as or instead of cleaning work etc. in connection with wind turbines.

It is also an object of the invention to provide a method and a device with which inspection, repair, treatment etc. of wind turbines, and especially wind turbine blades, can also be carried out in a relatively simple and economically practical manner, also in the case of sea-based wind turbines.

These and other objects are achieved with the invention as will be explained in more detail in the following.

According to the invention, a method for lifting and/or lowering of objects in connection with a wind turbine or a similar construction is characterised in that an uplift device is made to raise and/or lower itself in the proximity of the wind turbine or the similar construction, and in as much as the uplift device is possibly controlled in relation to the wind turbine or the similar construction, and that at least one object is supported by said uplift device, possibly as an integrated part of the uplift device.

Hereby, access is achieved to places on for example a wind turbine which are otherwise difficult to gain access to, for example on a rotor blade, without the necessity of having to arrange hoists, cranes, scaffolding or the like for use for this purpose.

The uplift device will be of a relatively light construction, which by means of a relatively light vehicle can be transported to the wind turbine, where it is filled with a suitable air or gas, which is lighter than the atmospheric air. When the uplift device, which for example can be of balloon type or the like, is filled with this air or gas, with suitable dimensioning it will have such a buoyancy that it can lift itself together with that or those objects which are supported by the device. The uplift device will at least be partly controlled in such manner that it moves to the desired position, including the desired height, in relation to the wind turbine, or moves in a desired path, for example along a rotor blade. It shall be noted that configuration, dimensioning, choice of materials etc. in connection with the uplift device can be effected in a wide variety of ways, as will be obvious to a skilled person.

It will be understood that by this method a large number of different objects i.e. for example articles, measuring and inspection equipment, spare parts, auxiliary equipment, tools etc., can be transported up to otherwise inaccessible placings or areas up in or at the wind turbine.

According to a preferred embodiment, such as disclosed in claim 2, said at least one object can consist of an arrangement for inspection, treatment or the like of at least part of the wind turbine or the similar construction.

If the device according to the invention supports or carries vision equipment, for example in the form of a camera which delivers pictures down to an operator, an inspection of a part of the wind turbine, for example of the surface of a rotor blade, can hereby be carried out in a relatively simple manner. Other forms of inspection equipment can also be envisaged, and the device can also carry relatively light equipment for e.g. processing, repair work or the like.

According to a preferred embodiment, such as disclosed in claim 3, said at least one object can consist of a locking device for the establishing of a securing to a part of the wind turbine or the similar construction. In a relatively simple manner, there can hereby be achieved an anchoring or fastening at a desired place on, for example, a wind turbine, after which such an anchoring can be used for further operations, work tasks or the like, for example tasks which require lifting of equipment of greater weight and/or extent than can immediately be handled by the uplift device alone.

According to a particularly advantageous embodiment, such as disclosed in claim 4, the invention relates to a method for establishing a securing on or at a wind turbine which is characterised in that
an uplift device is positioned in the proximity of the wind turbine, that
said uplift device is allowed to raise itself in an at least a partly controlled manner, and that
a locking device, which is carried by said uplift device, is made to grip in or around a part of the wind turbine in a preferable disengageable manner.

It is hereby achieved that an anchoring can be achieved on or at the wind turbine, without the necessity of having to arrange hoists, cranes, scaffolding or the like for use hereof.

This is achieved by the uplift device, which will be of a relatively light construction, being transported to the wind turbine by means of a relatively light vehicle, where it is filled with a suitable air or gas, which is lighter than the atmospheric air. When the uplift device is filled with this air or gas, with a suitable dimensioning it will have such buoyancy that it can lift itself and the locking device connected herewith. The uplift device will at least be partly controlled so that it moves to the desired position in relation to the wind turbine, where an activation of the locking device is effected so that this grips around or in a part of the wind turbine. It will be understood that the locking device is configured in such a manner that it can serve as an anchoring for lifting and/or lowering of various parts.

Such an anchoring can thus be used for lifting and/or lowering of work platforms, cleaning apparatus, various work equipment and personnel, and the possibility is hereby established of being able to lift and/or lower various parts such as spare parts or parts which must be replaced. Thus, with the method there will thus be achieved the basis for being able, for example; to replace a wind turbine blade in a relatively simple manner.

It shall be noted that said work operations shall be understood to be a wide range of operations or actions, which can be effected in connection with a rotor blade or a wind turbine as a whole. Here can be mentioned washing, other cleaning, drying, for example with air, heated air, radiation heating etc., painting, pre-treatment, after-treatment, sealing of the surface etc. Moreover, it can include inspection of the surface, examination of the surface or the rotor blade as such, for example by means of known inspection methods such as radiation examinations etc.

As disclosed in claim 5, the uplift device can expediently be allowed to raise itself in at least a partly controlled manner under control in relation to one or more fixed points on the ground, for example with the help of one or more lines.

In an expedient manner, there is thus achieved a control which is relatively simple and which can easily be established. For example, one or more ground spikes can be placed, mounted for example with eyes, tackles or the like, which serve to guide lines, ropes, wires or the like which lead up to the device according to the invention, and which can be handled by one or possibly several persons. Alternatively, a vehicle, or a vessel where a sea-based wind turbine is involved, can have such guide elements for lines, ropes, wires etc. mounted for example on arms which can be extended or unfolded to the correct positions. In most cases, the arrangement of said fixture points on a vehicle or a vessel is to be preferred, in that this will give the easiest and most rational handling, and it is also to be preferred for reasons of time. It shall be noted that the number of such lines will naturally depend on many conditions, but that there can be one, two, three, four or more. It shall also be noted that fixture points can be secured to the turbine tower or the foundation beforehand, for example moulded into the foundation, or use can be made of fixture points which are mounted subsequently, or which are mounted upon the use of the invention and subsequently dismounted again. Use can thus also be made, for example, of securing elements, which are fastened by means of vacuum/under-pressure, such as suction cups, or similar elements, or by means of magnetic forces, for example when the turbine towers in question contain iron, steel etc.

It shall be noted that if a mounting of the anchoring in connection with a wind turbine blade is concerned, it will normally be the case that the relevant blade is brought to point downwards towards the ground, and that the device according to the invention is placed under this blade. Moreover, in the preparation of the mounting it will be expedient to pay regard to the wind direction and strength, so that the wind turbine's nacelle is parked in such a position that the wind will blow towards the rotor. The wind turbine tower will be able to be used partly as control, in that the uplift device will be prevented by the wind turbine tower from moving in the wind direction.

According to a further expedient embodiment, such as disclosed in claim 6, the uplift device can be allowed to raise itself in a manner which is at least partly controlled in relation to one or more parts of the wind turbine, including the rotor blade and/or the wind turbine tower.

Hereby, in a relatively simple manner, a stable and reliable control of the uplift can be achieved. For example, the control can be effected by a noose or the like being wrapped around the tower and connected to the device according to the invention, after which the uplift can be controlled with a single line which is drawn by a person the opposite way of the tower, naturally while paying regard to wind direction etc. However, in a preferred embodiment, the control will take place with use being made of a winch or the like which is mounted on or in a vehicle or a vessel, so that control etc. can be effected in a simple and reliable manner. Preferably, the control is arranged in such a manner that a few persons and preferably only one can operate the device according to the invention.

Expediently, such as disclosed in claim 7, the locking device can be brought to grip on or around a wind turbine blade, preferably in the proximity of the root of the blade.

It is hereby achieved in a suitable manner that an anchoring for use for an apparatus or a work tool, such as for example a work platform, a washing robot or the like which is required to move up and down along a rotor blade, can be placed on the wind turbine in a relatively simple manner. The positioning in the proximity of the root of the rotor blade is particularly expedient, in that at this point the rotor blade will typically have a smaller cross-dimension, at least in one direction, so that an anchoring will be able to be established by narrowing-down a ring or the like, by allowing support elements or the like to go in against the blade or the like, so that security is achieved against the anchoring being drawn downwards.

According to a further expedient embodiment, such as disclosed in claim 8, the locking device can be brought to grip on or around a hub for the blades of the wind turbine.

With this expedient embodiment, an anchoring can be established which can be suitable for certain types of turbine, and which moreover can be used, for example, in the replacement and/or mounting of rotor blades.

According to an alternative expedient embodiment, such as disclosed in claim 9, the locking device can be brought to grip in or around the turbine tower.

With this embodiment, there can be achieved an anchoring which, for example, can be expedient when work is required to be carried out on the turbine tower itself, such as surface treatment, inspection, painting and/or repair of damages, including surface damages such as, for example, rust corrosion.

As disclosed in claim 10, the invention also relates to a device for lifting and/or lowering of objects in connection with a wind turbine or a similar construction, said device according to the invention being characterised in that the device comprises an uplift device, means for controlling the uplift device in relation to the wind turbine or the similar construction, and means for carrying at least one object, borne directly or indirectly by said uplift device.

By means of this device, access can be gained to places on for example a wind turbine which are otherwise accessible only with difficulty, for example on a rotor blade, without the necessity of having to arrange hoists, cranes, scaffolding or the like for use for this purpose.

The uplift device will be of a relatively light construction, which by means of a relatively light vehicle or vessel can be transported to the wind turbine, where it is filled with a suitable air or gas which is lighter than the atmospheric air. When the uplift device is filled with this air or gas, with suitable dimensioning it will have such a buoyancy that it can lift itself and the object or objects which are supported by the device. The uplift device will have means for at least partial control so that it can be moved to the desired position in relation to the wind turbine, or such that it can be moved in or along a desired path, for example along a rotor blade.

With an expedient embodiment, such as disclosed in claim 11, said at least one object can consist of an arrangement for inspection, treatment or the like of at least one part of the wind turbine or the similar construction.

With a device according to this embodiment, an inspection can be made of a part of the wind turbine in a relatively simple manner, for example of the surface of a rotor blade, if the device according to the invention supports or is equipped with vision equipment, for example in the form of a camera which transmits pictures down to an operating person. Other forms of inspection equipment can also be envisaged, and the device will also be able to carry relatively light equipment for e.g. treatment, repair or the like.

According to a particularly advantageous embodiment, such as disclosed in claim 12, the invention relates to a device for the establishing of a fastening on or at a wind turbine, said device being characterised in that it comprises
an uplift device and
a locking device,
   said locking device having means for gripping in or around a part of the wind turbine, preferably in a releasable manner.

It is hereby achieved with the device that a fastening can be established on or at a wind turbine, without the necessity of having to arrange cranes, including mobile cranes, hoists, scaffolding or the like for this purpose.

This is achieved by transporting the uplift device, which will be of a relatively light construction, to the wind turbine by means of a relatively light vehicle or vessel, where it is filled with a suitable air or gas, for example helium, which is lighter than the atmospheric air. When the uplift device is filled with this air or gas, with suitable dimensioning it will have such a buoyancy that it can lift itself and the locking device connected herewith. The uplift device will be at least partly controlled so that it moves to the desired position in relation to the wind turbine, where an activation of the locking device is effected so that this grips around or in a part of the wind turbine. It will be understood that the locking device is configured in such a way that it can serve as an anchor for lifting and/or lowering of various parts.

Such an anchoring can thus be used for lifting and/or lowering work platforms, cleaning apparatus, various work equipment and personnel, and there is thus also established the possibility of being able to lift and/or lower various parts such as spare parts or parts which are required for replacement. With the device, the basis will thus be established for being able, for example, to replace a wind turbine blade in a relatively simple manner.

It shall be noted that said work operations shall be understood to be a wide range of operations or actions, which can be effected in connection with a rotor blade or a wind turbine as a whole. Thus, it can include washing, other cleaning, drying, for example with air, heated air, radiation heating etc., painting, pre-treatment, after-treatment, sealing of the surface etc. Moreover, it can include inspection of the surface, examination of the surface of the rotor blade as such, for example by means of known inspection methods such as radiation examinations etc.

Such as disclosed in claim 13, the device can expediently comprise means for use for control during the uplift, which means can comprise lines or the like for control in relation to fixture points, for example on or at a vehicle or a vessel or possibly on the ground, or means for control in relation to a part of the wind turbine, for example a wind turbine rotor or the wind turbine tower.

Hereby, an expedient form of control is achieved, which is relatively simple and can easily be established. For example, one or more ground spikes can be used, mounted for example with eyes, tackles or the like, which serve to guide lines, ropes, wires or the like which lead up to the device according to the invention, and which can be handled by one or possibly more persons. Alternatively, a vehicle or a vessel, if the given wind turbine is sea-based, can have such guide elements for lines, ropes, wires etc. mounted on for example arms which can be extended or unfolded to the correct positions. As mentioned earlier, use can be made of other forms of fixture points, for example mounted on the turbine tower or the foundation, and mention can also be made of fixture elements which are mounted by means of magnetic forces, vacuum/under-pressure and the like.

It shall be noted that if a mounting of the anchoring in connection with a wind turbine blade is concerned, it will normally be the case that the relevant blade is brought to point downwards towards the ground, and that the device according to the invention is placed under this blade. Moreover, in the preparation of the mounting it will be expedient to pay regard to the wind direction and strength, so that the wind turbine's nacelle is parked in such a position that the wind will blow towards the rotor. Hereby, the wind turbine tower will be able to be used partly as control, in that the uplift device will be prevented by the wind turbine tower from moving in the wind direction.

In a relatively simple manner, there can hereby be achieved a stable and reliable control of the uplift. For example, the control can be effected by a noose being wrapped around the tower and connected to the device according to the invention, after which the uplift can be controlled with a single line which is drawn by a person the opposite way of the tower, naturally while paying regard to wind direction etc. However, in a preferred embodiment, the control will take place with use being made of a winch or the like which is mounted on or in a vehicle or a vessel, so that control etc. can be effected in a simple and safe manner. Preferably, the control is arranged in such a manner that just a few persons and preferably only one can operate the device according to the invention.

Such as disclosed in claim 14, the device can expediently comprise means for the fastening of elements for use in positioning, lifting, lowering or the like of apparatus or parts.

It is hereby achieved that immediate use can be made of the anchoring in practice. For example, mention can be made of eyes for securing, tackles or the like, and expediently mention can be made of those means, which are also used for securing of guide lines etc. It can be envisaged that the locking device, during the uplift, will carry relatively thin lines with it, and that when the anchoring is undertaken, thicker lines, ropes, wires or the like are drawn up to the anchoring by means of winches or the like mounted on, in or at the vehicle or the vessel. Hereby, the uplift will not be impeded by the weight of lines or rope with a dimension and herewith a weight which is necessary to be able to support the work equipment or the part which shall be lifted or lowered by means of the invention.

According to an expedient embodiment, such as disclosed in claim 15, said uplift device can comprise at least one element, for example a U-shaped, round or annular element, which can be filled with an air or gas, for example helium.

There is hereby achieved an expedient embodiment of the device, especially in connection with an anchoring which shall be established on a wind turbine blade. The device will take up relatively little space, as a part of the uplift can be taken care of by said element, which can be adapted to the space conditions, which exist between the wind turbine tower and the wind turbine rotor. The element can thus be made elongated and/or with a relatively small dimension where it is required to go in between tower and rotor. With a U-shaped configuration, the advantage is gained that the legs can be used for positioning, in that they can be placed on each side of the turbine tower and thus hereby serve as a control.

According to a further expedient embodiment, such as disclosed in claim 16, said uplift device can comprise at least two of said elements which can be filled with an air or gas, for example helium, and which are connected either directly or indirectly to said locking device.

It is hereby achieved that a large part of the uplift can physically be placed in places where the necessary spare is available, for example at the side of rotor blades etc. It is hereby avoided that there must be a relatively large uplift element which can be difficult to handle, and which will easily collide with parts of the wind turbine.

Such as disclosed in claim 17, the device can expediently comprise a U-shaped or annular element, for example by said uplift device comprising at least one element which is U-shaped, round or annular, and which can be filled with an air or gas, for example helium, whereby said U-shaped or round element can serve to control the device during lifting and/or lowering, for example in relation to a wind turbine blade.

It is hereby achieved that control of the device during lifting and lowering is limited to that distance which exists between the ground and the tip of the wind turbine. When the device has first reached so far up that the wind turbine blade is surrounded by the annular element, the device will be more or less completely controlled by the rotor blade. When a U-shaped element is used, this will moreover be able to be used also to control the uplift up to the tip of the wind turbine, in as much as the U-shaped element can grip around the turbine tower until the level for rotor tip is reached.

Such as disclosed in claim 18, the device can expediently comprise a frame arrangement, which is possibly annular, box-shaped or the like, and which is connected to the uplift device and/or the locking device. There is hereby achieved an expedient and suitable form of structure which can satisfy the strength requirements, and where by use of the readily available light construction materials such as carbon-fibre reinforced materials, plastics, alloys etc., a suitably low weight can be achieved so that the uplift volume can be held at a suitably low level, which is important with regard to the desire concerning a good control, also when there is a wind blowing.

With a further expedient embodiment, such as disclosed in claim 19, the device can comprise a control part, possibly in the form of a wind vane, which under influence of the wind at least partly can control the position of the device in relation to the direction of the wind. With the use of, for example, such a wind vane, which in principle is known from sailboats, a greater stability can be achieved during ascent and descent, so that even under windy conditions the use of the device will not be problematic.

According to a particularly expedient embodiment, such as disclosed in claim 20, said locking device can be configured in such a manner that a loading of the device will result in a force being transferred to said means for gripping on or around a part of the wind turbine.

Hereby, it will be achieved that the anchoring of the device which has been effected will be strengthened further when lifting or lowering is carried out, or when the device merely supports an object such as a washing robot, a machine, an instrument etc. Hereby, an increased lifting capacity for the device can be obtained as well as the security is improved.

The invention also relates, as disclosed in claim 21, use of a method according to one or more of the claims 1-9 and/or a device according to one or more of the claims 10-20 for lifting and/or lowering of a work platform, preferably in the treatment, inspection or the like of a part of a wind turbine, including especially a wind turbine blade As disclosed in claim 22, the invention further relates to uses of a method according to one or more of the claims 1-9, and/or a device according to one or more of the claims 10-20 for lifting and/or lowering of an arrangement for cleaning, washing, surface treatment etc., for example an arrangement in the form of a washing robot, for a part of a wind turbine and including preferably a wind turbine blade.

Moreover, such as disclosed in claim 23, the invention relates to the use of a method according to one or more of the claims 1-9 and/or a device according to one or more of the claims 10-20 for lifting and/or lowering of a part of a wind turbine, including especially a wind turbine blade.

Finally, such as disclosed in claim 24, the invention relates to the use of a method according to one or more of the claims 1-9 and/or a device according to one or more of the claims 10-20 for lifting and/or lowering of equipment, for example inspection equipment, vision equipment, measuring equipment etc., for inspection of a part of a wind turbine, including for example a wind turbine blade.

### THE DRAWINGS

In the following, the invention will be explained in more detail with reference to the drawings, where

FIG. 1 illustrates an embodiment of the invention in connection with a land-based wind turbine seen from the side,

FIG. 2a illustrates the same embodiment as shown in FIG. 1, with the device raised to the level of a blade tip,

FIG. 2b illustrates the embodiment shown in FIG. 2a with the device raised to the level of the blade root,

FIG. 2c illustrates in a manner corresponding to FIG. 2a a further embodiment of the invention,

FIG. 2d illustrates in a manner corresponding to FIG. 2c a further embodiment of the invention used in connection with a sea-based wind turbine,

FIG. 3 shows a vehicle which is arranged for use in connection with the invention, seen from above.

FIG. 4a illustrates the same embodiment as shown in FIGS. 1, 2a and 2b, with the device anchored to a wind turbine, where the device serves as anchor for a part which can be lifted and lowered in relation to the wind turbine,

FIG. 4b illustrates in a manner corresponding to FIG. 4a the use of the embodiment shown in FIG. 2c,

FIG. 5 shows a perspective view of a first embodiment of an uplift device according to the invention,

FIG. 6 shows a device according to the invention with an uplift device as shown in FIG. 5 in a position close to the hub of a wind turbine,

FIG. 7 is an enlarged detail view of the embodiment shown in FIG. 6,

FIG. 8 is a side view of the device shown in FIG. 6,

FIG. 9 is an enlarged detail view of the embodiment shown in FIG. 8,

FIG. 10 shows a locking device according to an embodiment of the invention seen in perspective,

FIG. 11a-c shows use of an embodiment of the invention in connection with a wind turbine tower instead of a rotor blade,

FIG. 12 shows a further embodiment of the device according to the invention seen from the side,

FIG. 13 shows the device shown in FIG. 12 seen in section from above and on a larger scale, and

FIG. 14 shows this embodiment seen from the rear from a position between turbine tower and rotor blade.

### DETAILED DESCRIPTION

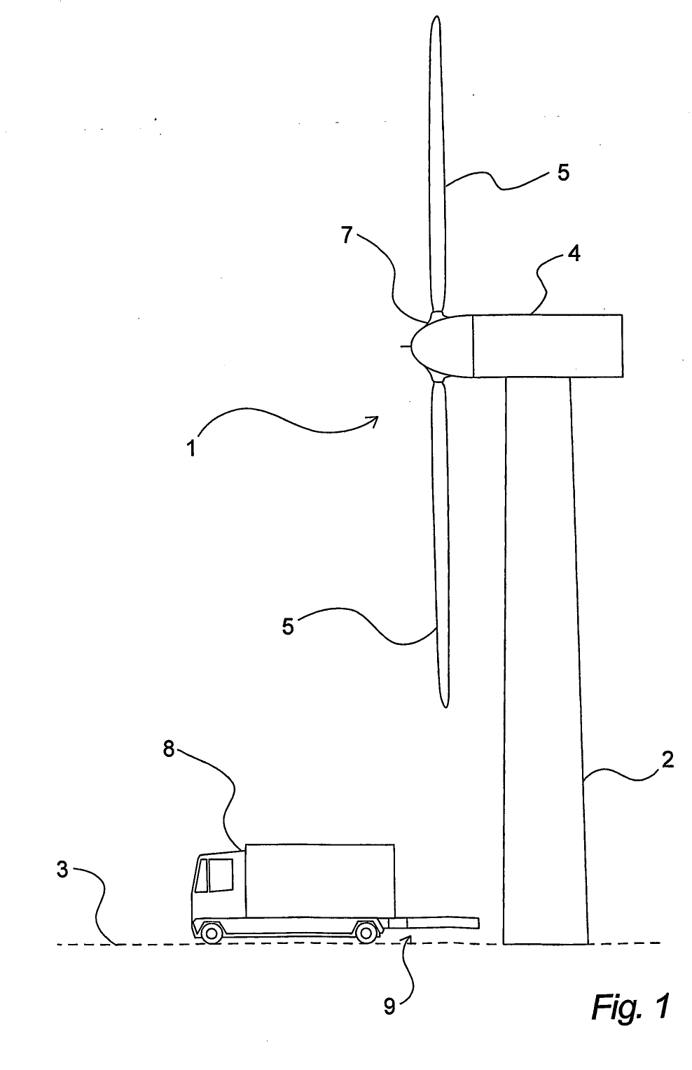

In FIG. 1 is shown a commonly known land-based wind turbine 1 seen from the side. Such a wind turbine 1 comprises a turbine tower 2 placed on a foundation on the ground 3. On the top of the turbine tower 2 a nacelle 4 is placed which contains generator, gear mechanisms, control equipment, bearings etc., and which in a commonly known manner can be turned depending on the direction of the wind. The nacelle 4 thus also supports the rotor hub 7 on which a number of rotor blades 5 are mounted—in the shown example three—as is most often the case. These rotor blades 5 are in a known manner arranged so that they can be turned substantially around a longitudinal axis with regard to wind speed etc. In connection with use of the invention, these rotor blades will most often be positioned so that they stand edgewise, i.e. turned so that the wind will blow substantially towards the leading edge (or trailing edge) of the rotor blades. Moreover, with the use of the invention, the nacelle 4 of the wind turbine will be brought into a position where the wind blows in towards—or away from—the rotor hub 7 of the wind turbine. Moreover, the rotor arrangement will be brought into a position where one of the rotor blades points substantially downwards towards the ground, and where the rotor blades are locked in this position.

A vehicle 8, for example a van, a small lorry or a trailer of a suitable size which can transport the necessary apparatus, is parked under the rotor blades 5 such as illustrated. For example, on the rear end of the vehicle 8 there can be arranged means 9 to assist in the execution of the invention, said means 9 comprising, for example, a work platform, possibly a lift or the like, as well as there can be arranged fixture points, tackles, lines, winches etc., such as will be explained in more detail later. Moreover, various means can be provided which can be extended, folded or swung out or the like, for example arms which can be unfolded, as will be explained in the following.

A device according to the invention (not shown in FIG. 1) can from the vehicle 8, possibly from a position on the ground behind the vehicle or from a possible work platform behind the vehicle 8, be brought into an active state, i.e. that an uplift device is filled with an air or gas which is lighter than the atmospheric air, for example helium, and furthermore a control of the device will be initiated, for example by lines or the like which can be fastened to the device beforehand, being fixed in relation to the vehicle 8 or the ground 3. The uplift device is filled with, for example, helium, from for example a tank on the vehicle 8, in as much as it shall be noted that in the event that the device has already been used in connection with another rotor blade or a nearby wind turbine, the device can already be partly filled with helium as well as the helium which is filled in can have been used to fill the device earlier, and is for example filled from a special storage tank into which helium can be pumped, for example back from the uplift device.

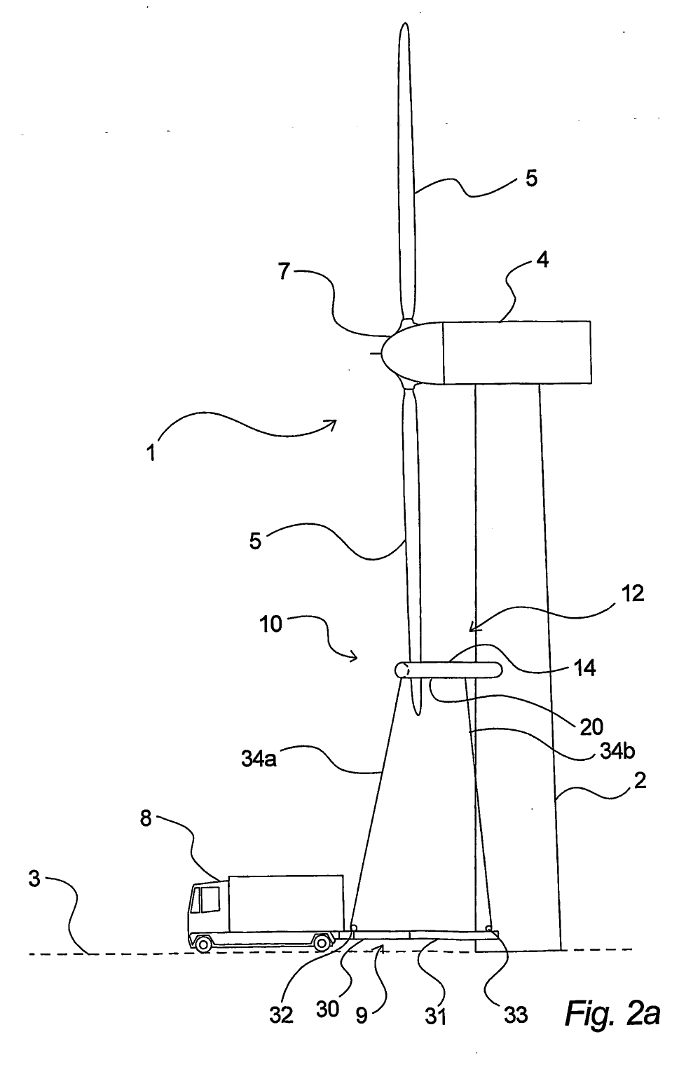

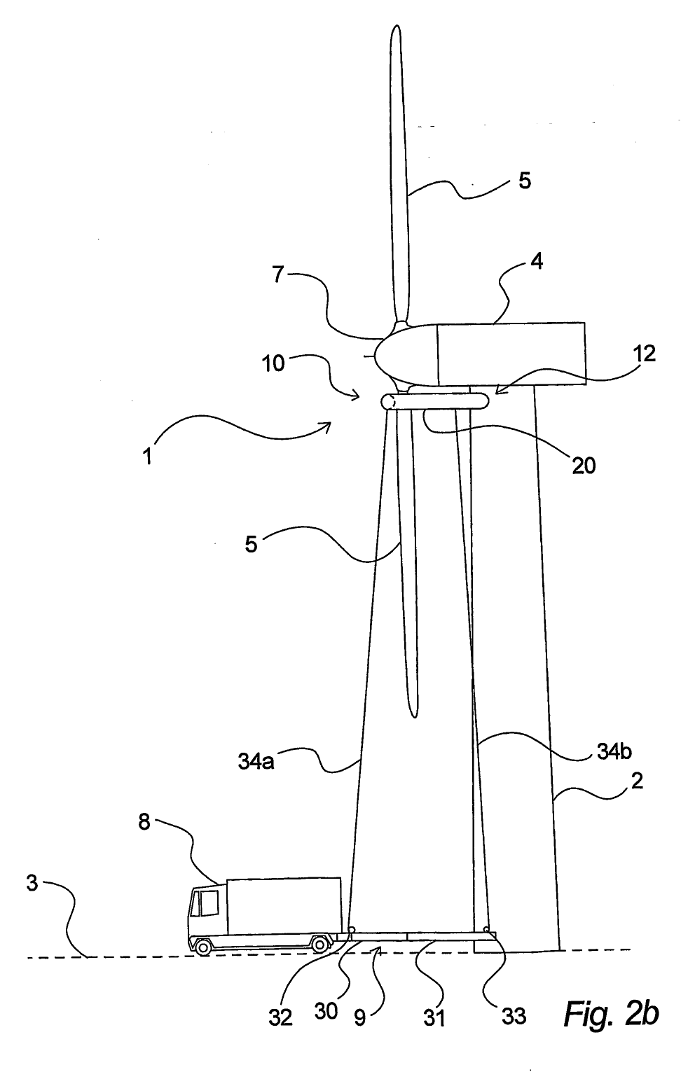

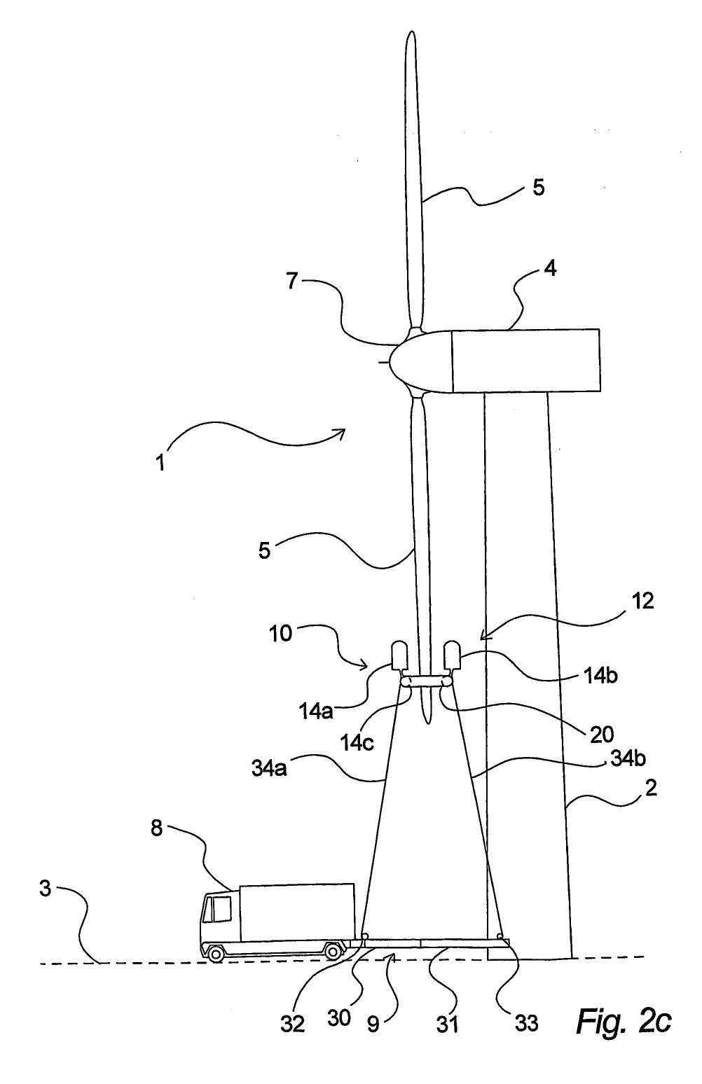

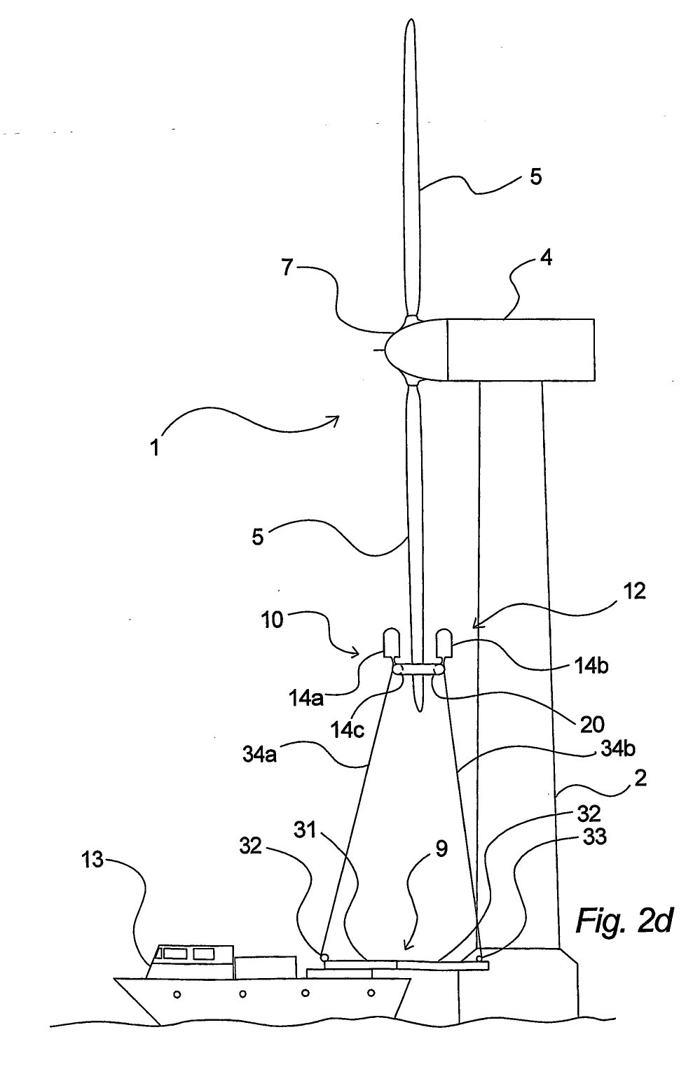

In FIG. 2a is shown such a device according to the invention, said device indicated in general by the designation 10, and which comprises an uplift device indicated in general by the designation 12, and a locking device indicated in general by the designation 26. In FIG. 2a the device 10 is shown in a situation where the uplift device 12 is filled with an amount of gas, for example helium, which is sufficient to lift the device 10 upwards towards the rotor blade 5. As shown, the device 10 can be controlled by means of lines, ropes, wires or the like (in the followed mentioned merely as lines) 34a and 34b, which from the device 10 extend down towards the vehicle 8 or towards the ground. Said lines 34a, 34b can be led down to fixture points in the form of eyes, tackles, winches or the like 32 and 33 which can be arranged on the part 9, for example on arms or the like 30 and 31 which can be swung, unfolded or extended from the vehicle, so that the fixture points 32 and 33 are positioned at suitable expedient places.

In the position shown in FIG. 2a, the device 10 has reached a position where it has reached the lowermost part of the rotor blade 5. As shown, the device can have a form where one or more parts are arranged to be controlled by the tower 2. For example, the device 10 or the uplift device 12 be configured with a substantially horseshoe-shaped fashion, so that the two legs extending rearwards can extend on each side of the tower 2, while the foremost closed part is positioned by the rotor blade as shown. In other embodiments, the device can be configured with an annular or a substantially round part, which can be moved up over the tip of the rotor blade 5, so that there is hereby achieved a control over the continued uplift.

In the position shown in FIG. 2b, the device 10 under control of the lines 34a and 34b has reached up in the proximity of the hub 7, i.e. at the root of the wind turbine blade 5, where by means of a locking device 20 an anchoring or locking to the rotor blade is effected, so that by means of the device there can for example be lifted objects of different kinds, apparatus, machines etc. up along the rotor blade, as will also be described later.

In FIG. 2c, which corresponds substantially to FIG. 2a, an embodiment of the device is illustrated where the uplift device 12 is configured with a substantially annular part 14c, and with separate uplift elements 14a and 14b. It will be understood that there can be several such uplift elements, which can possibly stand in connection with one another or can constitute separate chambers. It will also be understood that this embodiment can be combined with the embodiment shown in FIGS. 2a and 2b.

For further illustration of the invention, in FIG. 2d there is shown a situation corresponding to FIG. 2c, but where the given wind turbine 1 is water- or sea-based. In the same manner as described above, the uplift device 12 is filled with an amount of gas, for example helium, which is sufficient to lift the device 10 upwards towards the rotor blade 5. The device 10 can similarly be controlled by means of lines, ropes, wires or the like (in the following simply referred to as lines) 34a and 34b, which from the device 10 extend downwards towards the vessel 13. Said lines 34a, 34b can be led down to fixture points in the form of eyes, tackles, winches or the like 32 and 33, which can be arranged on the vessel 13 itself and/or on a part 9 which, for example as described above, can have arms or the like 30 and 31 which can be swung, unfolded or extended from the vessel so that the fixture points 32 and 33 are placed at suitably expedient places. It will be obvious that this sea-based application can also be effected with other embodiments of the device, including of the uplift device, for example the embodiment which is shown in FIGS. 2a and 2b.

It will also be understood that the method and the device according to the invention can be used for both land-based as well as water-based wind turbines, in as much as when the wind turbines are water- or sea-based, the only substantial difference will be that use is made of a vessel in the form of a barge, a work-boat, a smaller freight vessel or the like instead of a vehicle. It will thus also be understood that in the following where embodiments in connection with wind turbines on land are discussed, corresponding embodiments will find application with wind turbines at sea or water-covered areas in general. Thus, when a use in connection with a land-based wind turbine is discussed, this is not to be understood as a restriction in the use.

In FIGS. 2a-2d the uplift device is shown in stylised embodiments, in as much as it will be understood that it can be configured in a wide variety of ways, as will be obvious to an expert. As implied, the device can comprise several separate uplift elements 14a and 14b, which can be completely separated or can be connected with one another, so that they can be filled with air or gas at the same time. Moreover, there can be configured an annular part ¹⁴c which can also serve as uplift element. It will also be understood that generally speaking the uplift element or elements can be divided into several chambers, so that a seepage or leak is limited to a single or just a few chambers.

Said locking device 20, the function of which will be explained in more detail later, is illustrated in a general manner, and it will be understood that also this can be configured in a wide variety of ways.

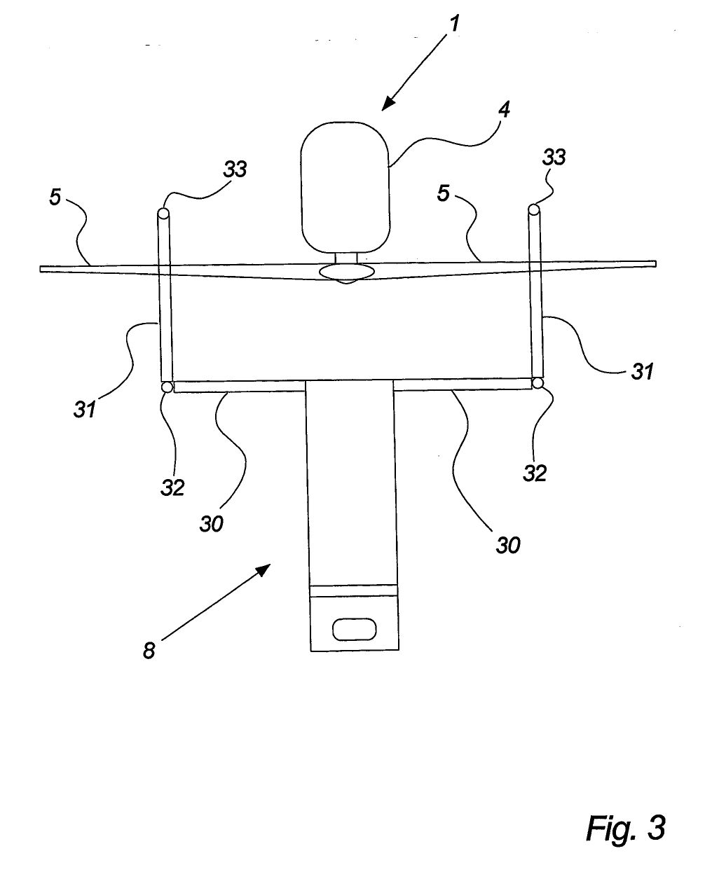

In FIG. 3 it is shown from above how the vehicle 8 and the fixture points 32 and 33 can be arranged in relation to a wind turbine 1 in the execution of the invention. As shown, the vehicle 8 (or a vessel in the event that the given wind turbine is sea-based), is placed so that the device 10 according to the invention (not shown in FIG. 3) can be placed under a rotor blade 5 before being raised, for example behind the vehicle 8. Also the arms 30 and 31 are illustrated which can be swung or unfolded from the vehicle 8, so that fixture points 32 and 33 on these arms are suitably positioned. These fixture points, which can naturally be placed differently and in numbers other than shown in FIG. 3, can be configured as simple eyes, as tackles, as winches or other means for controlling the lines 34a and 34b, which can possibly also be led to winches or the like existing on the vehicle 8 (or the vessel) itself It will be obvious that these fixture points can also be placed on the ground, for example by means of ground spikes or the like if the wind turbine is land-based. Furthermore, it will be obvious that the turbine tower itself or its foundation can be used as fixture point. The fixture points can thus be of the kind which are secured to the turbine tower or the foundation beforehand, for example moulded into the foundation, or fixture points which are subsequently mounted or which are mounted upon use of the invention and dismounted again afterwards. Use can thus also be made, for example, of fixing elements, which are secured by means of vacuum/under-pressure, such as suction cups, or similar elements, or by means of magnetic forces, for example when the wind turbine towers contain iron, steel etc. Similar securing elements or elements which correspond hereto are used within other technical areas, for example for the lifting or handling of items, and it will be obvious that these, for example after adaptation, can also be used in connection with this invention.

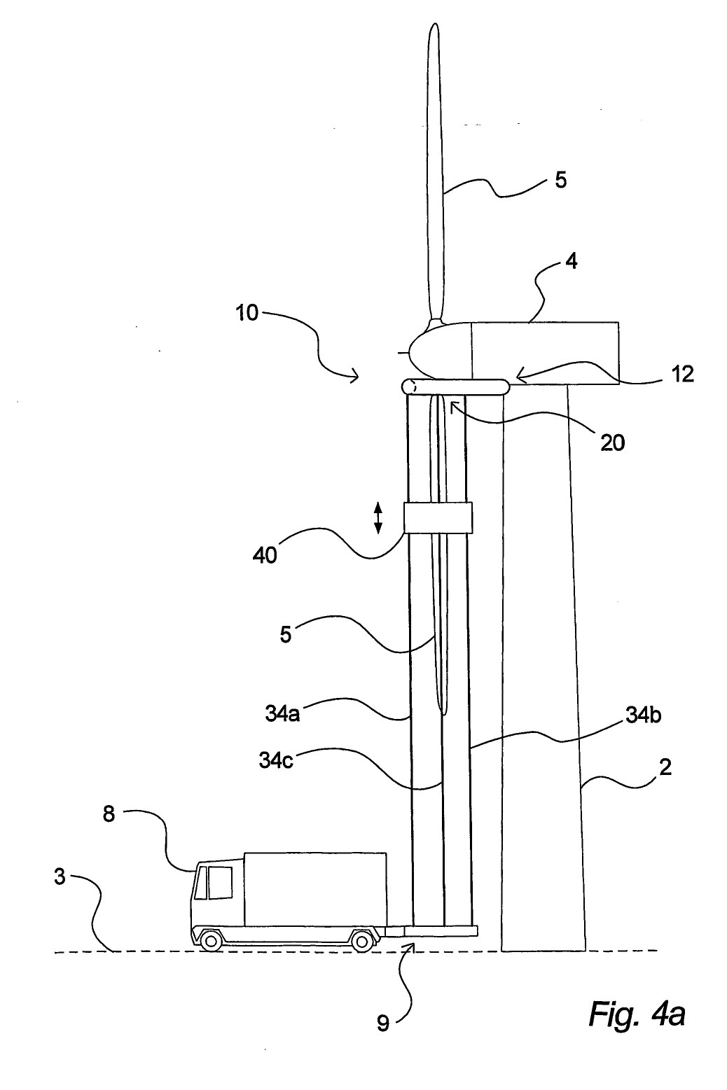

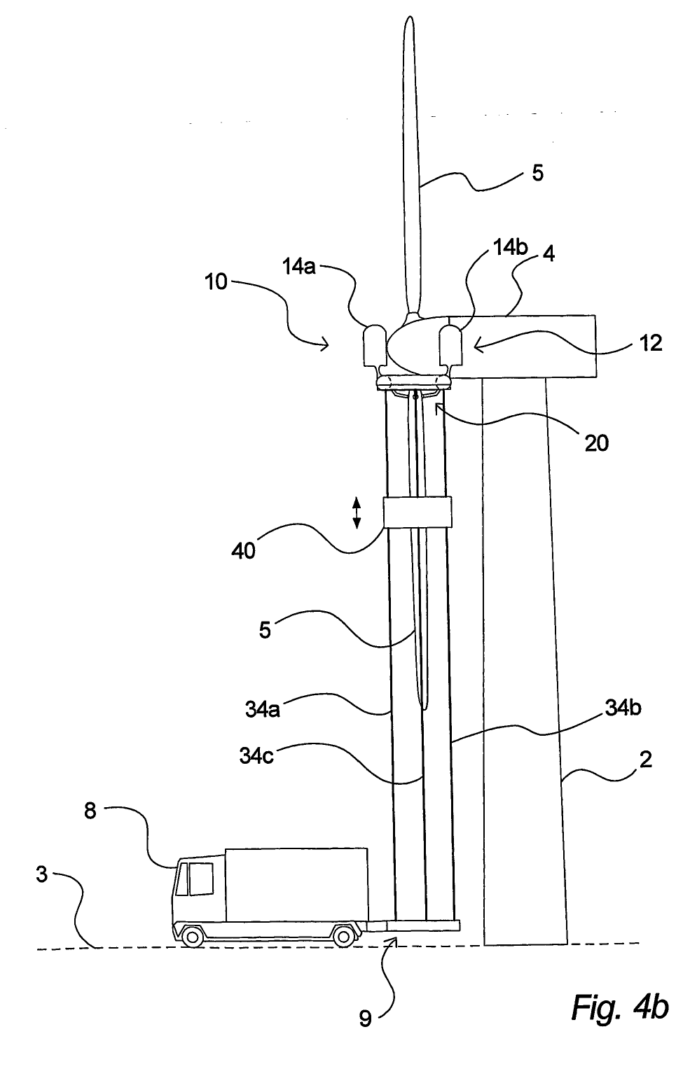

The actual locking of the device according to the invention and its function in this situation will be explained in more detail with reference to FIGS. 4a and 4b, which show the wind turbine 1, the vehicle 8 and the device 10 according to two embodiments of the invention seen from the side. When the device 10 according to the invention by means of the uplift device 12 reaches up in the proximity of or up to the root of the rotor blade 5, a locking will be effected by means of the locking device 20.

When it has reached up to the root of a rotor blade, where the rotor blade typically has a smaller dimension, at least in width, the locking device 20 can, for example, be brought to grip around the rotor blade, which can be effected by means of different means, as will be obvious to an expert. For example, support parts can be made to move in against the surface of the rotor blade, such as indicated in FIG. 4b, or an annular arrangement, for example of belt-like construction, can be tightened together around the rotor blade so that the anchoring arrangement 20 will sit firmly on the rotor blade 5, in as much as such locking can be effected by remote control or be initiated in another manner by an operator. It will be obvious that such a locking also will have to be released again when the work on the relevant rotor blade has been carried out. Other methods of carrying out this locking function are possible, as well as the locking or anchoring can be effected on other parts of the wind turbine than the rotor blades, for example on the hub 7 or other parts.

When the securing of the device 10 has been carried out, the device can be used to raise and lower various objects, parts, work equipment etc. up a down. For example, this can be effected by exerting a pull on the lines 34a, 34b and 34c, which were used to control the device during the uplift, in as much as these can possibly be led in tackles, winches or the like, and in as much as they are possibly led down to tackles, winches or the like at the vehicle 8 or at the auxiliary equipment 9. However, special lines or the like for lifting or lowering said parts etc. may also be used.

It shall be noted that if there are greater forces required to be exercised by means of said lines, the lines which were used for control during the uplift, or the special lines, can be replaced by lines of larger dimensions, in that the thinner lines which are used initially, for example 34a, 34b and 34c, are used to haul up thicker lines.

It shall further be noted that if a better locking of the device shall be effected than is immediately possible with said locking device alone, by means of said lines there can be hoisted up a further locking or anchoring arrangement after the first-mentioned locking device has locked the device firmly to the wind turbine, the rotor blade or the like. This additional anchoring arrangement, the weight of which can be such that out of practical regard the uplift device is not immediately calculated to raise this can, for example, by means of hydraulics, electrical auxiliary means etc., result in a stronger anchoring to the relevant part of the wind turbine.

Moreover, objects, parts, work equipment etc. can be hoisted up and down by these parts having winches, motors or the like with which to effect the movement up and down, in as much as the lines secured between the device 10 according to the invention and the vehicle 8, the vessel 13 and/or the ground 3 will thus be immovable. In FIG. 4a and b there is thus illustrated an item 40 which can be a work platform, a washing robot or the like which can be moved, for example, by pulling itself up or down by means of lines, wires or the like. It will thus be possible to undertake various treatments of the rotor blades, repairs, inspections, washing, sealing etc. Thus, an apparatus for the treatment of rotor blades of the kind disclosed in WO 03/048569 may be concerned.

It will similarly be understood that said parts can be hoisted up by said lines or the like being led over tackles or the like at the locked device 10, and thus that on or at the vehicle or the vessel there are winches, motors or similar auxiliary means which can pull said parts up and down. Other commonly-known configurations for winches and hoisting arrangements can also be used.

After a piece of work in connection with the relevant wind turbine or the relevant part of a wind turbine has been carried out, as mentioned earlier the locking of the device 10 can be released, for example by means of a remote control, after which the device according to the invention can be drawn down, for example by means of the lines 34a, 34b and 34c, and with the help of winches or the like on the vehicle 8. The possibility will also exist of emptying some of the gas from the uplift device 12, so that the uplift decreases sufficiently for the device to float down by itself, or such that the device will be easier to pull down. Such a controlled emptying of gas can possibly be effected by gas being pumped via a hose down to a special container on the vehicle 8. When the device 10 reaches down to a level under the tip of the rotor blade, the lowering can be stopped here if work operations are to be carried out in connection with one of the other rotor blades. The rotor blades can thus be allowed to move until one of the other blades is in a position where it points down towards the ground, for example approximately 120° with a three-bladed turbine, after which the rotor axle is locked again. Hereafter, the device according to the invention can again be allowed to lift itself towards the rotor hub, where the anchoring etc. can be effected as described above.

If, on the other hand, further work is not required to be carried out at the same wind turbine, the device 10 can be drawn all the way down or almost all the way down to the vehicle 8 (or the vessel), after which, if a number of turbines have been located together, for example in a wind turbine park, it can be moved to the next turbine which is to be serviced or the like.

If work is not to be carried out in connection with further wind turbines at the same place, the gas or air existing in the uplift device can be pumped back to a special container so that it can be reused later. However, if use is made of helium, it will also be possible to let it escape into the atmosphere, which will not have detrimental consequences e.g. for the environment. For reasons of economy, however, it will be preferred that the gas is pumped back to a container for renewed use.

It shall be noted that the uplift device 12 and its possible additional uplift elements shall naturally be arranged so that they move free of the parts of the wind turbine, and including especially the rotor blades. Moreover, the arrangement can be configured so that during its ascent, and when it reaches the uppermost level, it will occupy the space which will be available to as great a degree as possible without colliding in any way with the parts of the wind turbine.

Moreover, it shall be noted that the device according to the invention can also be used without the presence of a locking device or, if this is present, without it being used. For example, this can be the case where lighter equipment shall be lifted and/or lowered in relation to the wind turbine. This can thus include vision equipment, for example a camera etc. or other inspection equipment which is to be lifted up to and be led along the surface of e.g. a rotor blade, for example in order to be able to detect the condition of the surface, defiling etc. of the surface of the rotor blade. This equipment can be lifted by means of the uplift device, which, as mentioned, can be controlled in relation to the rotor blade, whereby the desired inspection can be carried out during ascent and/or descent. Use of a locking device will thus not be necessary in this and similar cases, such as will also appear from the patent claims.

The uplift element 12 itself and possible separate uplift elements can be produced in suitably gas-tight materials which are preferably configured by materials which are also secured against leaks, i.e. for example that they are tear- and puncture-proof and in general resistant to the mechanical influences to which they are exposed during use. This or these uplift elements can be provided with various straps, securing of locking device or the like, or a special enveloping such as a harness arrangement, so that influences, traction etc. from wires, lines, locking devices etc. will be distributed over large parts of the uplift device's uplift elements. Use can also be made, however, of a special chassis, a frame or the like, which serves to support and carry uplift elements and locking devices, fastening for lines, winches etc., which will be explained in more detail in the following. Furthermore, it shall be noted that said uplift element or elements can each be configured as single chambers, or that there can be a dividing up into several separate chambers.

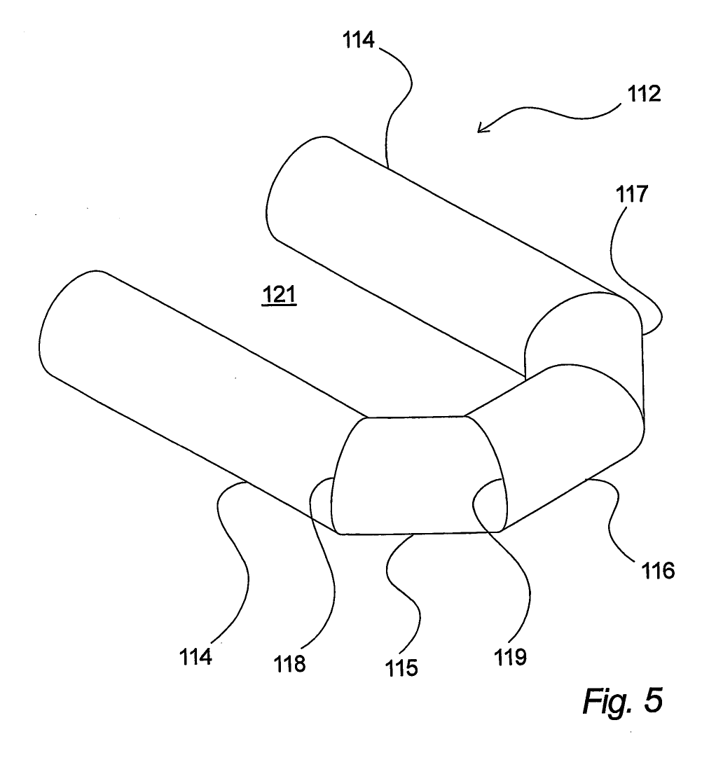

On a larger scale in FIG. 5 there is shown an uplift device 112 according to a particularly expedient embodiment of the invention. As will be seen, this arrangement is substantially U-shaped or shaped like a horseshoe. It is thus composed of a number of uplift elements 114, 115, 116 and 117, which can consist of flexible chambers, which are filled with a gas, for example helium, which is lighter than the atmospheric air. These elements can be cylindrical and can be separated, for example at the joints 118 and 119, but can also form a continuous chamber. As will be seen, the elements 114 form the rearwards-pointing legs of the U, while the elements 115, 116 and 117 form the closed end. There is thus formed a space 121 which is large enough to accommodate the rotor blade, and which also has such a width, at least at the open end, which can grip around the turbine tower or at least around a section or a part of the periphery of the turbine tower.

Said uplift elements can be configured and produced as already described earlier.

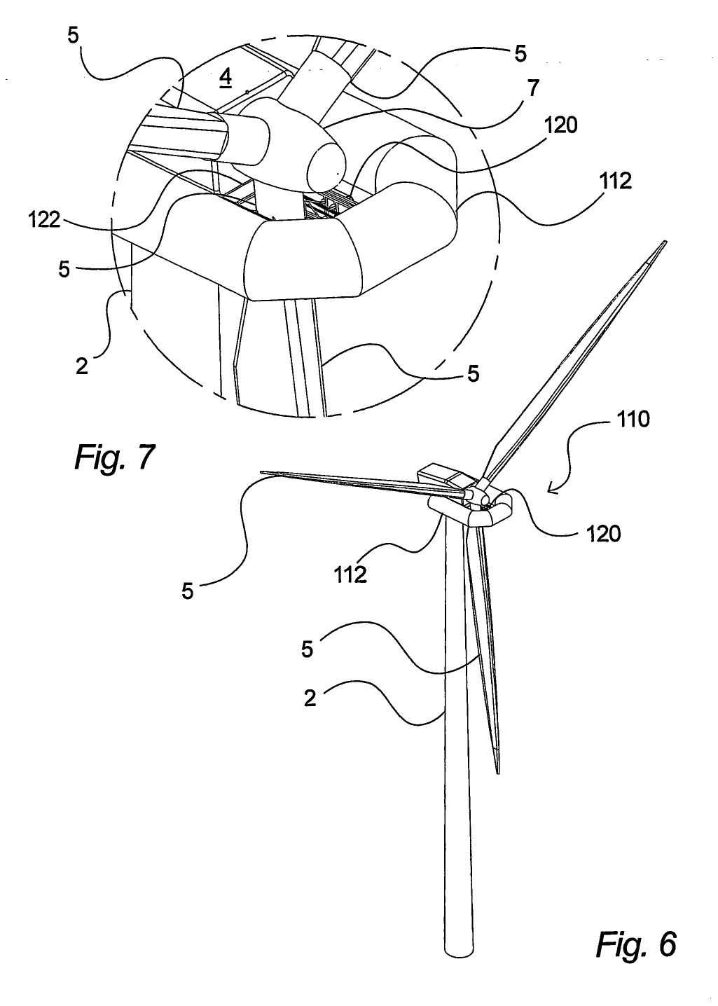

In FIG. 6 there is shown such an uplift device 112 as a part of a device 110 according to yet another embodiment of the invention, which also includes a locking device 120. The device 10 is shown in a position where it has reached up to the root of a rotor blade 5, controlled for example by means of lines (not shown) and by an interaction between the U-shape of the device and the rotor blade and the tower. In this position, the locking device 120 is activated so that the device 110 can serve as an anchoring for lifting and lowering of items.

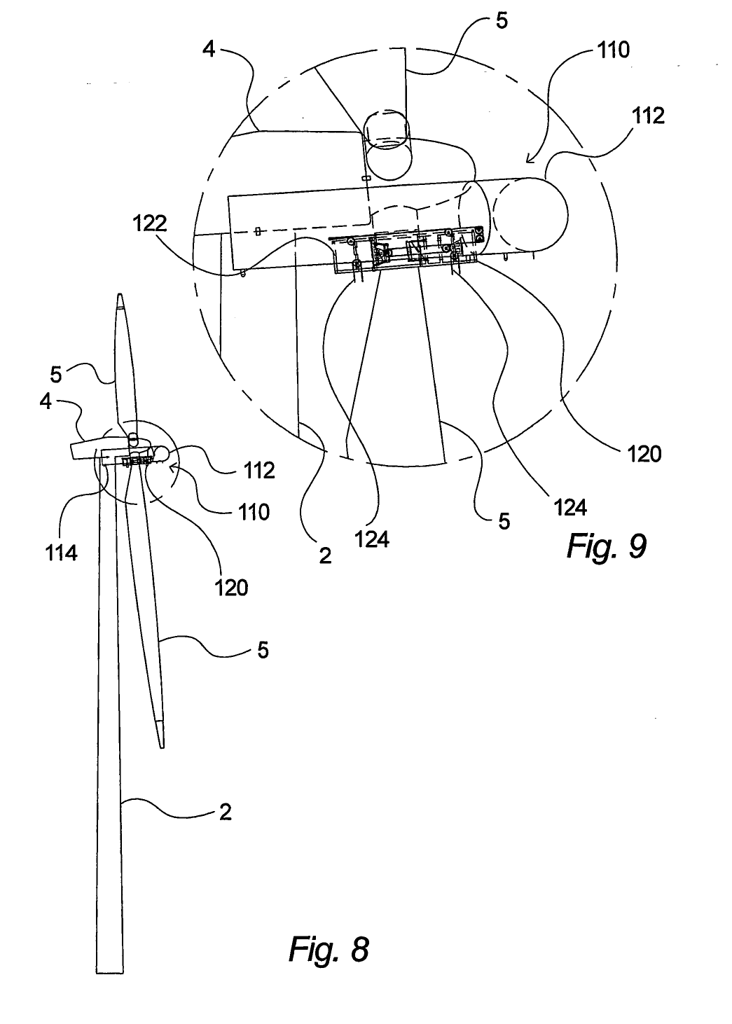

On a larger scale in FIG. 7 there is shown a detail section of the embodiment shown in FIG. 6, and here it is seen how the locking device 120 is disposed inside the uplift device 112. There is also shown a frame 122 for the locking device which, as will be understood, can be connected to the uplift device 112.

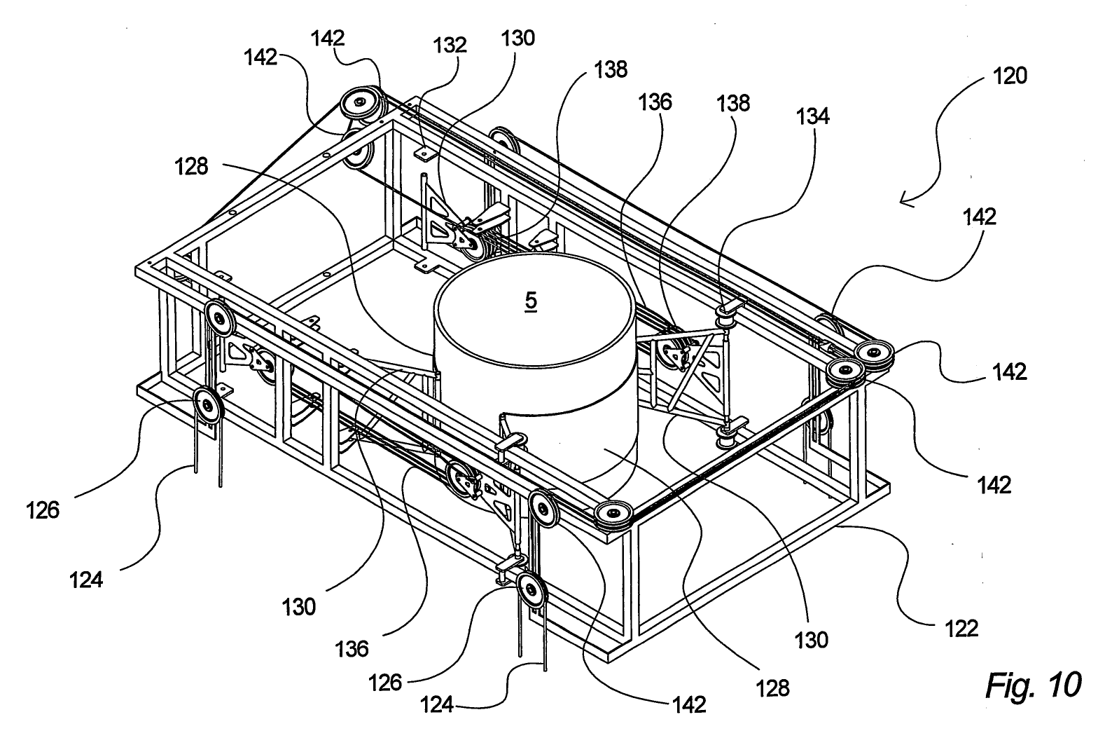

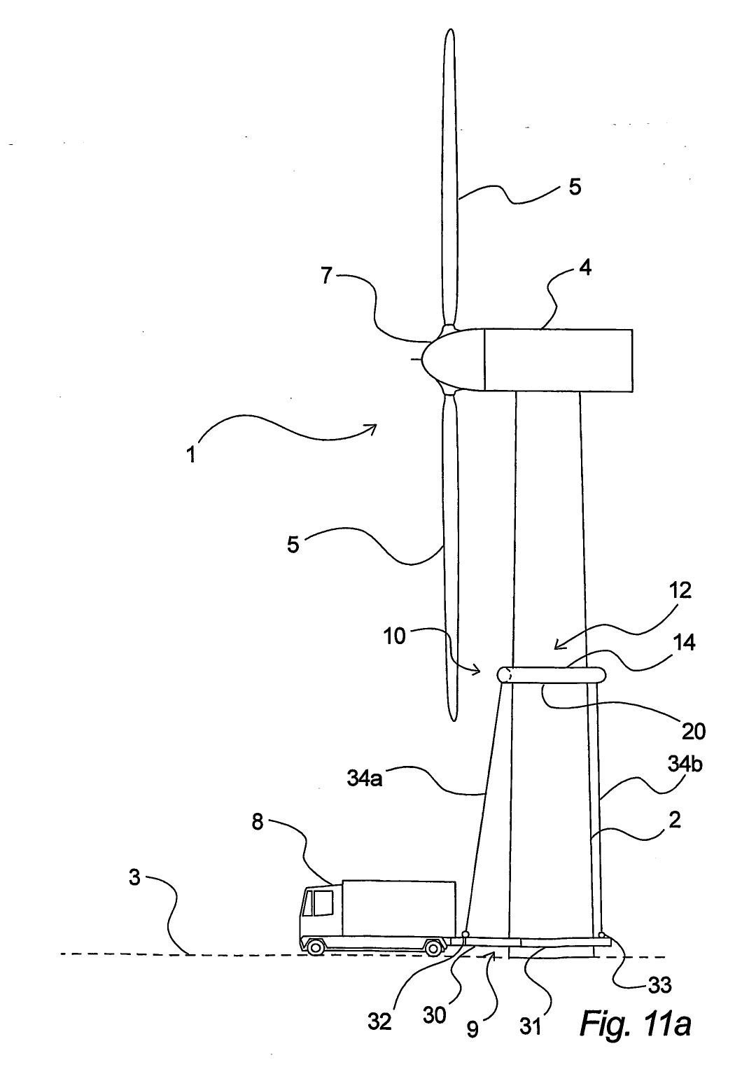

In FIGS. 8 and 9 this embodiment is seen from the side, where FIG. 9 is an enlarged detail section of FIG. 8. Also seen in these two figures is the locking device 120 and it's positioning in relation to the uplift device 112. In FIG. 9 it is also shown that on the frame 122 wires, lines and the like 124 can be mounted which can be used in the lifting or lowering of items. It will be understood that these lines or wires 124, of which for example there can be four on a frame 122, can possibly be used for controlling the uplift of the device, but that there can also be separate lines (not shown in FIG. 9) for this purpose.

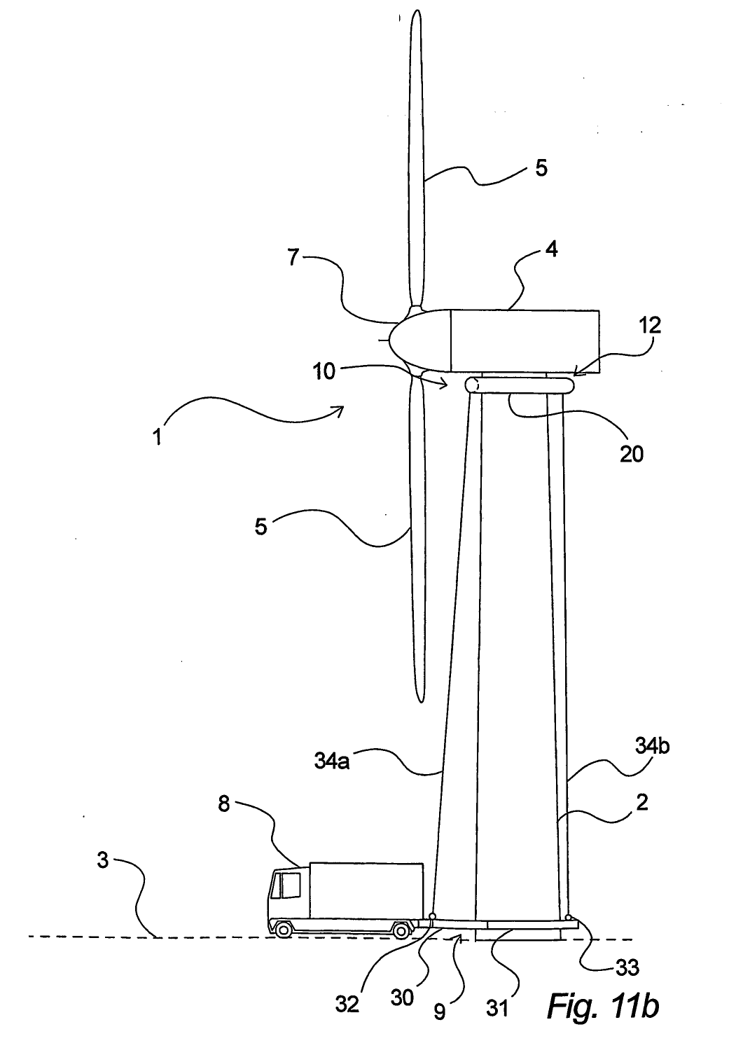

An example of a locking device 120 as shown in the foregoing FIGS. 6-9 is shown on a larger scale in FIG. 10. In this figure it is shown how the locking device 120 can clamp around the root of a rotor blade 5, where the rotor blade has a smaller extent and for example can have an approximately circular cross-section as shown, or for example around the top of a wind turbine tower 2. As mentioned earlier, the locking device has a frame 122 which, for example, can be produced in tubular or bar materials, and as shown can be in the form of a box-like construction. The clamping together or the locking is effected by means of two clamping plates 128 which can be configured from a flexible material so that these adapt themselves to the surface of the root of the rotor blade, but they can also be configured with a relatively static shape. That side of the clamping plates 128 which faces towards the rotor blade can be configured with a surface which in structure and/or material ensures a good friction to the rotor blade. It can thus be a surface coating of a rubber material which, for example, can also have a pattern, grooves, projections or the like on the surface to provide a good grip.

Said clamping plates 128 are each mounted on each side by means of two arms 130. These four arms 130 are suspended in a pivotal manner in relation to the flame 12, for example by bearings 132 and 134. Moreover, it will be understood that the arms 130 and the clamping plates 128 are pivotally connected, so that the clamping plates 128 can be turned back and away from the rotor blade 2. Moreover, the bearings for the one or both clamping plates can be configured in such a manner that they can be displaced in the longitudinal direction for the frame 122. For example, the bearings 134 for the one clamping plate can as shown be configured so that at the top and bottom of the frame 122 they can be moved along the frame.

Moreover, the clamping plates 128 can be drawn together towards each other and towards the rotor blade by, for example, each arm being mounted with multiple pulleys 138, which by use of a rope, a wire, a line or the like 136 form part of a tackles system so that an exchange is achieved. As shown in the upper side of the figure, the free end of the line 136 extends to the end of the frame 122 where it changes direction via two pulleys 142, after which it extends to the other end of the frame. Here it changes direction again and is led to yet another pulley 142 which is mounted above a pulley 126 for one of the lines 124, which is used for the lifting and lowering of objects. This arrangement is seen, for example, on the front of the frame in FIG. 10, and it is seen that the line which draws the clamping plates 128 together extends down to said pulley 126. This pulley is suspended in such a manner that it can be moved in the vertical direction, and thus it will be understood that when this pulley 126 is loaded, for example when an object such as an instrument or an apparatus is suspended in the lines 124 or is lifted up by these, a traction will be applied on the line 136, and the clamping plates will be pressed in towards the rotor blade 5 or the turbine tower 2 with greater force. The anchoring of the device according to the invention will thus be reinforced by loading in this manner.

It will be understood that such an arrangement can be configured in innumerable ways, and that the embodiment shown in FIG. 10 is only just one of these. It will also be understood that the initial clamping together of the clamping plates, from a position where they are turned outwards towards the frame, can be effected by these being turned inwards to the position shown in FIG. 10, after which the clamping together can be effected by means of a system as described above. Upon the releasing of the clamping together, the clamping plates can vice versa be turned outwards, after which the arrangement can be lowered again, in that the rotor blade or the turbine tower can thus now pass through the frame 122. However, it will be obvious that other configurations can be used. It is also obvious that the locking device can be configured in many different ways, so that the clamping plates or the like can be brought so far away from each other that, for example, a rotor blade can pass unhindered through it despite its varying width, after which the clamping plates can again be brought in against the rotor blade, after which a locking or clamping-together can be effected. Mention can thus be made of the clamping plates being brought towards each other in two stages, first a stage where a movement is preferably effected over a relatively large distance and without the use of any particularly great force, and thereafter a stage where the clamping plates are brought towards each other and herewith also the remaining part in against a rotor blade, a turbine tower or the like, with use being made of a relatively great force, so that a sufficient anchoring is achieved.

It will also be understood that the number and the configuration of said clamping plates can be varied within the scope of the invention, as will be obvious to a skilled person.

In the foregoing, the use of the invention is first and foremost illustrated in connection with rotor blades on wind turbines where, for example, objects shall be lifted up in relation to the rotor blade, or where work operations are to be carried out on or at the rotor blade. It is obvious, however, such as also mentioned earlier, that these operations can involve lifting, work or the like in connection with or in relation to other parts of a wind turbine, for example the nacelle or the tower.

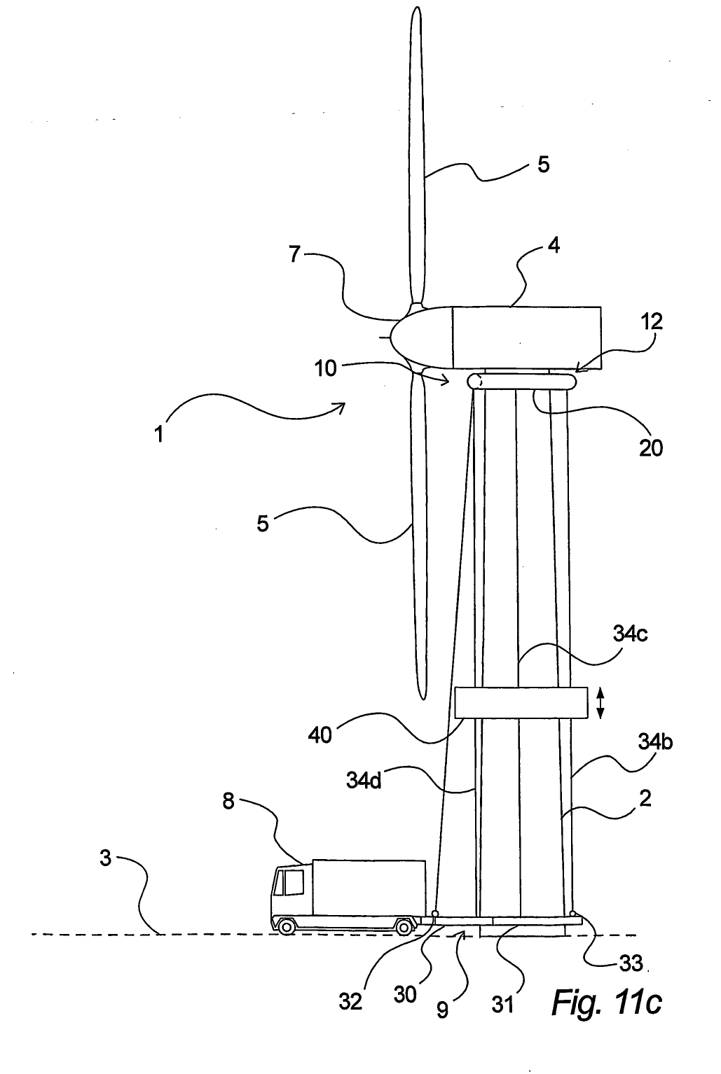

It is thus also obvious that such tasks can be carried out with a device as described, which for example is used to establish an anchoring on a rotor blade. However, it will be understood that an anchoring can be established on other parts of the wind turbine, and similarly that the lifting up can be effected in ways other than those described above. As an example of this, in the following and with reference to fig. 11a-11c, there will be described a use of an embodiment of the invention corresponding to that which, among other things, is described in connection with FIG. 2a, 2b and 4a, but in connection with a wind turbine tower.

In FIG. 11a it is thus shown how a device 10 according to an embodiment of the invention can lift itself in relation to a turbine tower 2, where in the same manner as described in connection with FIGS. 2a and 2b it is controlled by means of lines 34a and 34b which are connected to fixture points 32 and 33 on or at a vehicle, possibly on outrigger arms 30 and 31, or on or at the turbine tower 2 etc. It will be understood that the device 10 has initially been brought to the foot of the turbine tower 2, and in as much as the U-shaped uplift elements 14 are arranged with the legs on each side of the turbine tower. With the uplift, the device is thus also controlled by the turbine tower itself.

Where the device 10 comprises a locking device 20 which extends all the way around the turbine tower during the uplift, the device is arranged in such a manner that an opening can be effected so that it can be pushed in around the turbine tower and subsequently closed again. However, it will be obvious that use can be made of embodiments of the locking device 20 which can immediately be disposed around or at the turbine tower 2.

In the same manner as described earlier, the device 10 is allowed to lift itself until it reaches the desired height, for example as shown in FIG. 11b, where it has essentially reached up to the underside of the nacelle. Here, the locking device can be activated so that an anchoring to the turbine tower is established. Hereafter, the device 10 can be used to lift various objects in relation to the wind turbine, as shown by way of example in FIG. 11c, where e.g. a washing or cleaning robot, a work platform or the like 40 can be hoisted up and down (or can move up and down) by means of lines or the like 34b, 34c, and 34d, which can be the same lines as those used to control the uplift of the device, or which can be special lines which are used only for the raising and the lowering of an object. Different working operations can hereby be carried out on the turbine tower, such as for example especially surface treatment, rust work, cleaning, grinding, painting, inspection etc. However, as also mentioned in connection with the foregoing embodiments, it is obvious that various work tasks can also be carried out during the uplift and/or the lowering of the device 10 itself.

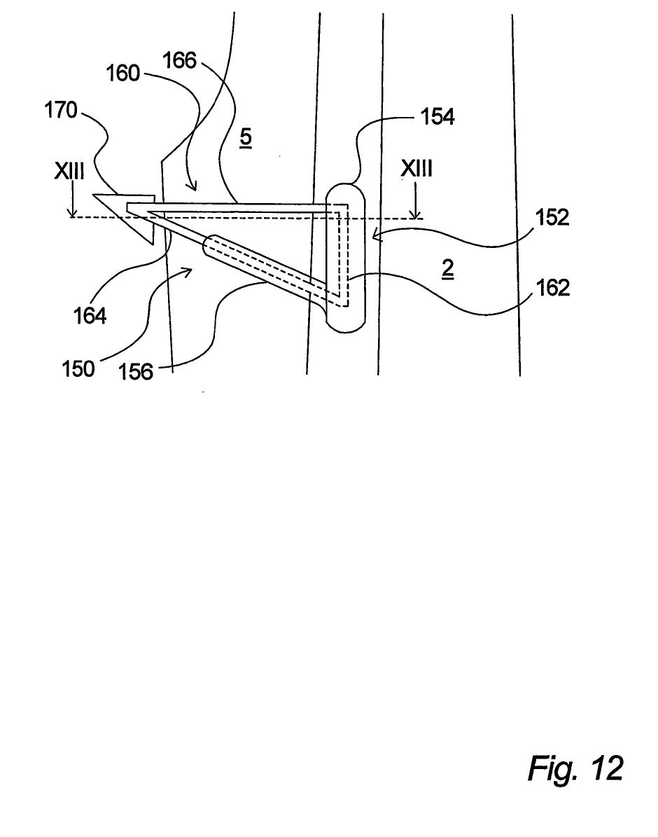

In FIGS. 12, 13 and 14 there is shown a further embodiment of a device according to the invention, where said device, which is indicated in general by 150, comprises an uplift device 152 and a locking device.

As shown in FIG. 12, which on a slightly larger scale shows an embodiment of the device 150 seen from the side in the proximity of the root of a rotor blade 5, the device 150 comprises a frame, a bracket or the like 160 which serves substantially to support and carry the essential construction parts of the device. As shown, the frame 160 has an upper part 166, which—in the position shown—in the proximity of the turbine tower 2 is connected to a part 162, which extends downwards. At the lower part of this there is connected a part 164 which extends upwards to the outer part of the frame part 162. The frame 160 preferably forms a closed figure, which can surround the rotor blade 5. The uplift device 152 can comprise several parts, which are connected to or surround frame parts. In connection with the frame part 162 there is thus disposed a larger uplift part 154 which is also connected to an uplift part 156 which extends along the frame part 164. It is obvious that uplift parts could also be connected to the remaining frame parts, and it can also be mentioned that the uplift elements could extend along the frame also at the parts which are lying away from the turbine tower, i.e. the outer parts of the frame.

As shown, at the outer part of the frame 160 there can be arranged one or several wind vanes 170 which, in a similar manner to the systems known from e.g. sailboats, serve to exercise an automatic controlling of the device according to the invention, so that this will always face against the direction of the wind, or in general be controlled in relation to the wind direction.

It shall be noted that the frame 160 as well as the frame 122 described in connection with FIG. 10 will be made of parts, which fulfill the requirements with regard to both strength and minimal weight. Use can thus be made of materials such as aluminium, other alloys, synthetic materials such as carbon fibre or glass-fibre reinforced plastic materials, including polyester, epoxy etc., as well as other materials such as wood, especially including light woods such as balsa wood can be used. Use can also be made of a composition of different materials, for example wood, for example balsa, reinforced with various plastics such as glass-fibre or carbon reinforced polyester, epoxy etc. Furthermore, composite materials in general will be able to be used. As will be obvious to an expert, other possibilities of selection among materials, which are available at any given time, can also be used.

It shall also be noted that the frame can be configured in ways other than as shown. There can thus be various forms of lattice constructions configured from bars and/or tubes. Moreover, the construction can comprise plate-formed parts, as well as constructions with features from several of the above-mentioned constructions are possible. Tubular or hollow parts of the frame construction itself can also serve as uplift elements, i.e. they can be configured in an air-tight manner and with the possibility of filling the cavity with a gas or air which is lighter than the atmospheric air. For example, this can be done by providing such a cavity with a flexible inner bag which can be filled with said gas or air, and where this gas or air can also be pumped out again while the inner bag folds together inside the cavity.

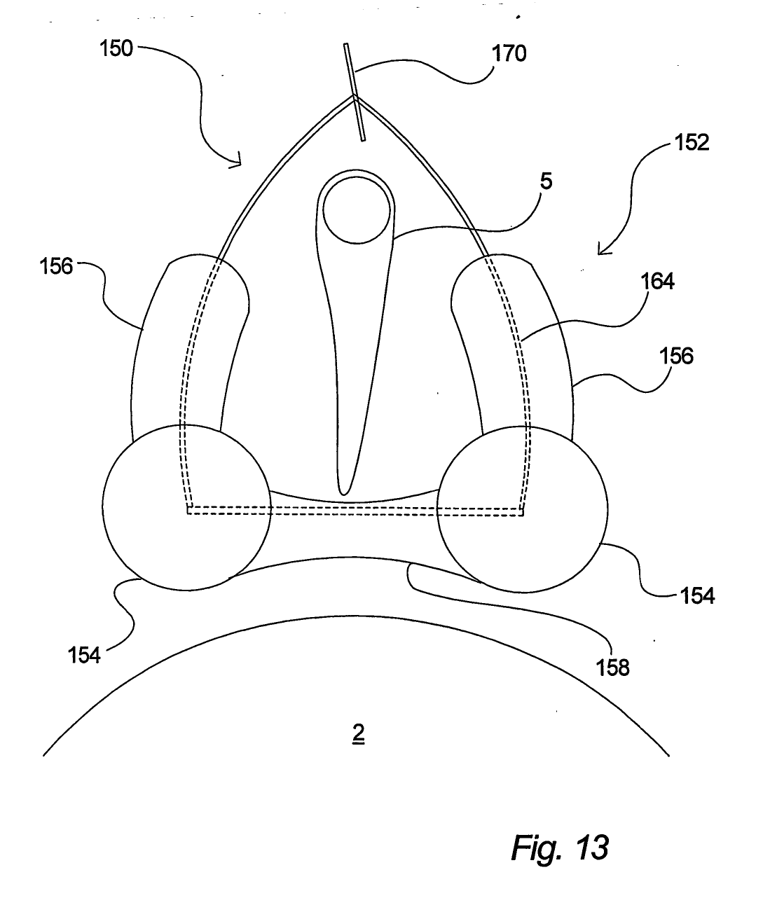

In FIG. 13 the device 150 is shown on an even larger scale in a section along the line XIII-XIII in FIG. 12. There is thus shown an expedient positioning of the uplift parts 156 and 154 along the respective frame parts, and it is also seen that the uplift parts 154 are connected by a transverse uplift part 158. It is thus also seen that with this embodiment an optimal positioning of the uplift elements is achieved, at the same time as the space available between the turbine tower 2 and the rotor blade 5 is utilised.

In a special embodiment, said frame or rack part is configured in such a manner that it can be folded together, so that in addition to being relatively light it will only occupy very little space when it is to be transported, stored etc. This can be effected, for example, by the frame parts being configured in a known manner with lock parts and/or hinges, for example so that in a substantially triangular form a de-coupling takes place between two sides at one corner, after which these two sides are folded down towards the third side, in that hinges are arranged at the two last corners. It will be obvious to an expert that the frame construction can be configured with other forms of collapsibility.

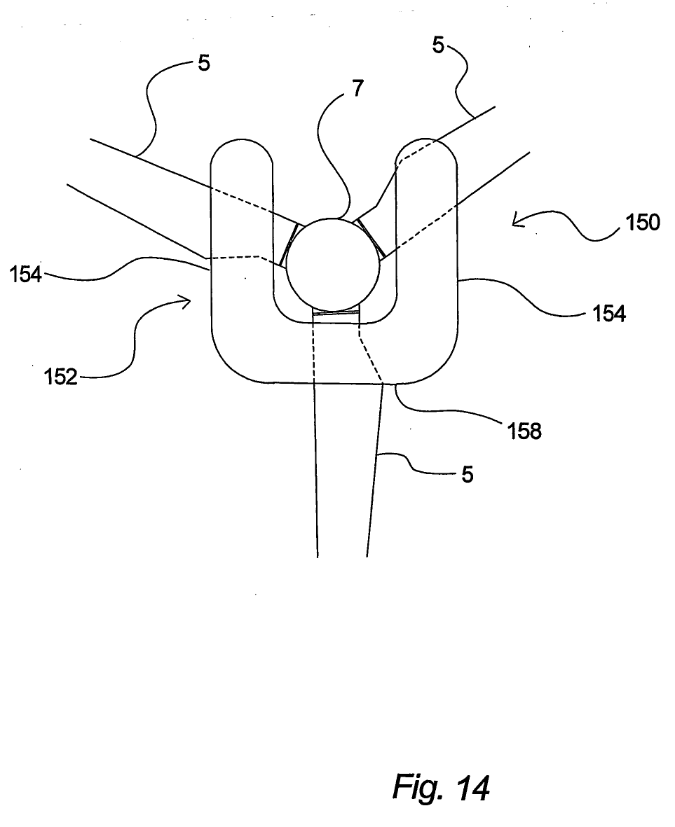

In FIG. 14 the device according to this embodiment of the invention is shown seen from the rear from a position between turbine tower and rotor blade 5. As will be seen, the device 150 and the uplift device 152 form a horseshoe-like shape in the vertical plane. It will be understood that the frame, which is not shown in this figure, can be included as an integrated part of the device and, in the case where such an arrangement is present, can also serve to support the locking device (not shown in this figure) or other means, technical arrangements etc. In the position shown, where the device has been elevated to the hub of the rotor blades, the locking device can be configured so that it can grip around the root of a rotor blade 5. The locking device can, however, also be configured so that it can grip around the hub 7 itself for the rotor blades. It will also be realised that the locking device can be configured in such a manner that it can grip around or in any other suitable part of the wind turbine and/or parts of this. As mentioned earlier, a locking device can be dispensed with in cases where the lifting of relatively light materials, camera equipment, inspection equipment etc. is involved, where use of only the uplift device alone will be adequate for carrying out lifting and lowering.

As will be understood from the foregoing, with the invention the possibility is achieved of being able to carry out a wide variety of work operations in connection with wind turbines, without the necessity of having to procure relatively costly and resource-demanding material such as cranes etc. Moreover, this can be effected in a relatively simple manner, and several wind turbines can be serviced in a relatively short time, such as will be exemplified in the following.

With a group of wind turbines or in connection with a wind turbine park, a device according to the invention can be brought to the site by means of a relatively simple vehicle or a vessel, which in addition to the device according to the invention shall bring with it a supply of said gas or air, pump equipment for handling of this, required winches, lines, tackles and the like, and control equipment, including remote control. To this can possibly be added equipment which is to be hoisted up in the wind turbine, such as work platform, camera equipment, for example for inspection or to assist in the control, equipment for use e.g. for cleaning or treatment of parts of the wind turbine including the rotor blades etc.

As mentioned, the vehicle or the vessel is placed under a wind turbine blade when the wind turbine has been stopped in a certain position in relation to possible wind, for example with the rotor blades towards the wind and with a rotor blade pointing downwards. The device according to the invention is unfolded on the vehicle or the vessel, possibly on a platform or the like on the vessel or the vehicle, for example on the back of it. For reasons of the relatively low weight, a single person can carry this out. The said gas or air is pumped into the uplift element or elements of the device, and at the same time or prior to this the control equipment of the device is made ready, i.e. the connecting of lines from the device to one or more fixture points on the vessel or the vehicle, or possibly on outrigger arms on the vessel/vehicle or on the ground. Hereby, the device will be ready to lift itself when it is filled with a sufficient amount of uplift gas.

At this time, the device can be allowed to lift itself, controlled by means of said lines or in other ways, for example by a control also in relation to the turbine tower, so that it will raise itself towards the tip of the downwards-pointing turbine blade.

With use of the embodiment shown in FIGS. 2a and 5-8, the uplift towards the blade tip can also be effected under control in relation to the turbine tower, in as much as the horseshoe shape or at least the rearwards-extending parts will be able to grip around the tower, and thus serve to control the uplift towards the tip of the blade. Moreover, a possible wind, which as mentioned earlier will come in towards the wind turbine mainly from the front, will help to keep the device in the right place.

By means of the control, for example the lines, the device engages the tip of the turbine blade, for example by the foremost closed end of the device, by a possibly annular part of the device, for example a frame construction or the like.

During the uplift to the tip of the turbine blade, a possible wind vane or the like can contribute towards maintaining the position of the device, as mentioned earlier. It shall be noted that even if the existing wind conditions should prove to be unfavourable, this will not be any substantial hindrance to the use of the invention. Even if strong gusts of wind should cause the device to move in against rotor blade or other parts of the wind turbine, this will not have damaging consequences since the device is configured with a low weight, and since it is thus configured and of such materials that it can not damage, for example, the surface of a rotor blade.

When the device has engaged the tip of the wind turbine blade, the remaining part of the uplift will be controlled partly by the interaction between the turbine blade and the shape of the device, for example a horseshoe shape, an annular or corresponding shape and, if the device is horseshoe shaped, the rearwards-extending legs will move on each side of the turbine tower and hereby control the position of the device. But in addition to this, an aerodynamically correct configuration of the device, possibly combined with one or more wind vanes, can be contributory in ensuring that also during the remaining part of the uplift the device is placed correctly in relation to turbine tower and rotor blade, also during relatively hard and/or changing wind conditions. If necessary, however, correcting controls can possibly be effected by means of said lines, winches etc. during the uplift.

When the device has moved up to its target, for example to the root of the rotor blade, the uplift is possibly halted, or the device can quite simply be allowed to abut against hub, nacelle or other part, which as mentioned above cannot give rise to damage. Possibly by means of a camera, it can be ascertained whether the device is placed correctly, so that in this position the locking device can grip correctly around the relevant part of the wind turbine. The locking device can, if necessary, be operated by a remote control, after which it is firmly locked. The work tasks desired to be carried out are now effected as described earlier, for example by lifting/lowering of a work platform, washing equipment, processing or inspection equipment etc.

When this work has been concluded and the relevant equipment has been lowered down again, the locking device is released, for example by a remote control, and the device according to the invention is lowered or allowed to descend, in that gas is pumped back to a container on or in the vessel or the vehicle as described earlier. If the gas is of a kind, which is not detrimental to the environment, it can possibly be allowed to be released.

As mentioned earlier, the device can be used without using a locking device, for example for the inspection of e.g. rotor blades, where it is simply a desire to effect an upwards and/or downwards movement along the rotor blade with a camera or the like, for which a locking is not required.

If further operations are to be carried out on the same wind turbine, for example on another blade, the device is only brought down to a height which is slightly below the level of the tip of the blade. Hereafter, the rotor blades are rotated until the next rotor blade is pointing downwards, after which the device is allowed to lift itself again and engage the tip of the new blade, possibly after gas has been pumped back into the uplift element or elements of the device, preferably from said tank or tanks for the reuse of gas. Hereafter, the process is repeated as described.

When no further working operations are required on the relevant wind turbine, the device is drawn—or lowered—completely or almost completely down to the vessel or the vehicle, possibly with gas being led from the device to said tank. If work is to be carried out in connection with other wind turbines in the vicinity or in the same wind turbine park, the vessel or the vehicle is moved over to the next wind turbine and the process is repeated. If no further work on wind turbines is required, the device is completely emptied of air or gas and is folded/packed together in the vessel or the vehicle, after which it will be immediately ready for use in another place.

As will be noted, with this method there will also be far better possibilities of being able to work on or at a wind turbine when it is windy than with the traditional methods, where a crane, e.g. a mobile crane, is used to effect a lift. In strong or hard wind, such a crane can be in danger of colliding with a part of the wind turbine and cause damage, especially offshore where this risk is increased by rough seas. This risk is avoided by means of the invention, partly due to the better control at the heights involved, for example by effecting the uplift along a rotor blade and possibly controlled in relation to the turbine tower, and partly due to the light weight and configuration of the device, which prevents damages even though an abutment against a part of the wind turbine should occur.

In the foregoing, the invention is described with reference to concrete embodiments and as shown in the figures. It is obvious, however, that the invention can be varied in various ways within the scope of the following claims.

As mentioned, there will thus be many possibilities for the configuration of the locking device, if such an arrangement is present as well as the possibilities of variation of the frame construction and the use of materials are innumerable.

With regard to the uplift device, there is possibility of variation in, among other things, number, shape, arrangement etc., and there are wide possibilities for use of various kinds or air and gas, where under the given conditions it is merely required that an uplift in relation to the surrounding air is achieved.

### List of Reference Designations

1 Wind turbine
2 Turbine tower
3 Ground
4 Nacelle
5 Rotor blade
7 Rotor hub
8. Vehicle
9. Auxiliary equipment on vehicle
10, 110 Apparatus according to the invention
12, 112 Uplift device
13 Vessel
14, 14a, 14b, 14c Uplift elements
20, 120 Locking device
30, 31 Outrigger arms
32, 33 Fixture points or the like for wires
34a, 34b Lines, wires or the like
40 Washing robot, work platform or the like
114, 115, 116, 117 Uplift elements
118, 119 Joints between uplift elements
121 Space in uplift device
122 Frame
124 Lines, wires or the like for lifting
126 Pulleys for lifting
128 Clamping plates
130 Arms for clamping plates
132 Bearing for arm
134 Movable bearing for arm
136 Lines, wires or the like for clamping together
138 Multiple pulleys, tackles block
142 Pulleys
150 Device according to the invention
152 Uplift device
154, 156, 158 Uplift parts
160 Frame
162, 164 Frame parts
170 Wind vane

1-24. (canceled)

25. Method for lifting and/or lowering of objects in connection with a wind turbine or a similar construction, the method comprising
making an uplift device lift itself and/or lower itself in proximity of the wind turbine or the similar construction;
controlling the uplift device in relation to the wind turbine or the similar construction; and
supporting at least one object by said uplift device.

26. Method according to claim 25, wherein said at least one object comprises a device arrangement for inspection, treatment or the like of at least one part of the wind turbine or the similar construction.

27. Method according to claim 25, wherein said at least one object comprises a locking device for an establishing of an anchoring to a part of the wind turbine or the similar construction.

28. Method according to claim 25, further comprising:
establishing an anchoring on or at the wind turbine, the establishing comprising:
positioning the uplift device in the proximity of the wind turbine;
allowing said uplift device to raise itself in a manner which is at least partly controlled; and
bringing a locking device, which is borne by said uplift device, to grip in or around a part of the wind turbine in a releasable manner.

29. Method according to claim 25, the method further comprising:
allowing the uplift device to raise itself in a manner which is at least partly controlled, under control in relation to one or more fixture points on, in or at a vehicle, a vessel and/or on the ground by means of one or more lines.

30. Method according to claim 25, the method further comprising:
allowing the uplift device to raise itself in a manner which is at least partly controlled, under control in relation to one or more parts of the wind turbine, including a wind turbine blade or the wind turbine tower.

31. Method according to claim 27, wherein the locking device is brought to grip in or around a blade in a vicinity of a root of the blade.

32. Method according to claim 27, wherein the locking device is brought to grip in or around a hub for blades of the wind turbine.

33. Method according to claim 27, wherein the locking device is brought to grip in or around a turbine tower.

34. Device for lifting and/or lowering of objects in connection with a wind turbine or a similar construction comprising:
an uplift device;
means for controlling the uplift device in relation to the wind turbine or the similar construction; and
means for carrying at least one object supported directly or indirectly by said uplift device.

35. Device according to claim 34, wherein said at least one object comprises a device for inspection, treatment or the like of at least a part of the wind turbine or the similar construction.

36. Device according to claim 34, wherein, for the establishing of an anchoring on or at the wind turbine, the device further comprises a locking device having means for gripping in or around a part of the wind turbine in a releasable manner.

37. Device according to claim 34, further comprising:
means for control during uplift, said means comprising lines or the like for control in relation to fixture points on, in or at a vehicle or a vessel or on the ground; and/or
means for control in relation to a part of the wind turbine.

38. Device according to claim 34 wherein, the device further comprises means for fastening of elements for use in positioning, lifting, lowering of apparatus or parts.

39. Device according to claim 34, wherein said uplift device further comprises at least one U-shaped, round or annular element, which can be filled with an air or gas.

40. Device according to claim 39, wherein said uplift device comprises at least two of said elements which can be filled with an air or gas, and which are connected directly or indirectly to a locking device having means for gripping in or around a part of the wind turbine in a releasable manner.

41. Device according to claim 34, further comprising a U-shaped or round element, which is filled with an air or gas lighter than air whereby said round element serves to control the device during lifting and/or lowering.

42. Device according to claim 34, wherein, the device further comprises a frame device which is connected to the uplift device and/or the locking device.

43. Device according to claim 34, further comprising a control part, which, under influence of wind, can at least partly control a position of the device in relation to a wind direction.

44. Device according to claim 36 wherein said locking device is configured in such a manner that a loading of the device will result in a transfer of a force to said means for gripping in or around a part of the wind turbine.

45. The a method according to claim 25, further comprising lifting and/or lowering a work platform in at least one of a treatment and an inspection of a part of the wind turbine including a wind turbine blade.

46. The method according to claim 25, further comprising lifting and/or lowering a device for cleaning, washing, or surface treating a part of the wind turbine including a wind turbine blade.

47. The method according to claim 25, further comprising lifting and/or lowering a part of the wind turbine including a wind turbine blade.

48. The method according to claim 25, further comprising lifting and/or lowering at least one of inspection equipment, vision equipment, and measuring equipment for inspection of a part of the wind turbine including a wind turbine blade.

49. Method according to claim 25, wherein said making the uplift device lift itself comprises providing the uplift device with a gas lighter than air to cause an upwardly lifting force on the uplift device.

50. Device according to claim 49, wherein the gas is helium.
